(19) United States
(12) Patent Application Publication
(10) Pub. No.: US 2026/0046689 A1
(43) Pub. Date: Feb. 12, 2026

(54) MODEL SELECTION AND SWITCHING

(71) Applicant: QUALCOMM INCORPORATED, San Diego, CA (US)

(72) Inventors: Jay Kumar SUNDARARAJAN, San Diego, CA (US); Chenxi HAO, Beijing (CN); Taesang YOO, San Diego, CA (US); June NAMGOONG, San Diego, CA (US); Naga BHUSHAN, San Diego, CA (US)

(21) Appl. No.: 19/103,091

(22) PCT Filed: Aug. 18, 2023
(86) PCT No.: PCT/CN2023/113688

§ 371 Date: Feb. 11, 2025

(30) Foreign Application Priority Data
Sep. 30, 2022 (WO) PCT/CN2022/123108

(51) Int. Cl. H04W 28/06; H04W 24/02

(52) U.S. Cl. CPC H04W 28/06; H04W 24/02

(57) ABSTRACT

Certain aspects of the present disclosure provide techniques for model selection and switching. In some aspects, a user equipment (UE) may perform compressed communication between the UE and a network entity using a first model, determine a condition based at least in part on channel state information, transmit an identifier associated with a second model to the network entity based at least in part on the condition, and perform compressed communication between the UE and the network entity using the second model. Numerous other aspects are described.

### CROSS-REFERENCE TO RELATED APPLICATION

This Patent application claims priority to PCT Patent Application No. PCT/CN2022/123108, filed on Sep. 30, 2022, entitled “MODEL SELECTION AND SWITCHING,” and assigned to the assignee hereof. The disclosure of the prior Application is considered part of and is incorporated by reference into this Patent Application.

### BACKGROUND

### Field of the Disclosure

Aspects of the present disclosure relate to wireless communications, and more particularly, to techniques for selecting models for compressed communication and switching between models for compressed communication.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and types of wireless communications mediums available for use, and the like. Consequently, there exists a need for further improvements in wireless communications systems to overcome the aforementioned technical challenges and others.

### SUMMARY

One aspect provides a method for wireless communication by a user equipment (UE). The method includes performing compressed communication between the UE and a network entity using a first model; determining a condition based at least in part on channel state information; transmitting an identifier associated with a second model to the network entity based at least in part on the condition; and performing compressed communication between the UE and the network entity using the second model.

Another aspect provides a method for wireless communication by a network entity. The method includes performing compressed communication between the network entity and a UE using a first network entity model; receiving, from the UE, an identifier associated with a UE model for compressed communication between the UE and the network entity; determining compatibility information associated with the UE model and each network entity model of a plurality of network entity models; and performing compressed communication between the network entity and the UE using a second network entity model based at least in part on the compatibility information.

One aspect provides a method for wireless communication by a UE. The method includes determining a condition based at least in part on channel state information; transmitting, to a network entity, a condition identifier associated with the condition or one or more model identifiers respectively associated with one or more models; receiving, from the network entity, a switching indication that indicates whether to switch from a first model to a second model; and performing compressed communication with the network entity using the first model or the second model based at least in part on the switching indication.

Another aspect provides a method for wireless communication by a network entity. The method includes receiving, from a UE, a condition identifier associated with a condition or one or more UE model identifiers respectively associated with one or more UE models for compressed communications between the UE and the network entity; obtaining an indication of whether to switch from a first network entity model to a second network entity model based at least in part on the condition identifier or the one or more UE model identifiers; and selectively transmitting, to the UE, a switching indication that includes an identifier associated with a UE model that corresponds to the second network entity model.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B. 4C, and 4D depict various example aspects of data structures for a wireless communications network.

FIG. 5 depicts physical channels and reference signals in a wireless network.

FIG. 6 depicts machine learning models.

FIG. 7 depicts a process flow for communications in a network between a UE and a network entity.

FIG. 8 depicts a process flow for communications in a network between a UE and a network entity.

FIG. 9 depicts a method for wireless communications.

FIG. 10 depicts a method for wireless communications.

FIG. 11 depicts a method for wireless communications.

FIG. 12 depicts a method for wireless communications.

FIG. 13 depicts aspects of an example communications device.

FIG. 14 depicts aspects of an example communications device.

### DETAILED DESCRIPTION

Aspects of the present disclosure provide apparatuses, methods, processing systems, and computer-readable mediums for selecting models for compressed communication and switching between models for compressed communication.

A user equipment (UE) and a network entity (NE) may communicate using an artificial intelligence (AI) model and/or a machine learning (ML) model. The AI/ML model may be used for communicating compressed information between the UE and the network entity, such as compressed information associated with channel conditions or reference signal measurements. The UE and the network entity may be configured with different models or different variations of the models. The UE-side model may need to be compatible with the NE-side model for the compressed information included in the communications to be accurately decoded. For example, the UE may determine a channel measurement, may generate a compressed communication based at least in part on a UE-side model that includes the channel measurement, and may transmit the compressed communication to the network entity. If the network entity is able to receive the communication and accurately decode the channel information using an NE-side model, the UE-side model and the NE-side model may be considered to be compatible. Alternatively, if the network entity is not able to accurately decode the channel information included within the communication, the UE-side model and the NE-side model may be considered incompatible.

In one example, the UE may detect a change in a condition, and may switch from a first UE-side model to a second UE-side model that is able to process information associated with the condition. By way of example, conditions may include any of: the UE switching between an indoor state and an outdoor state; the UE switching between line-of-sight communications and non-line-of-sight communications; the UE switching between a first vendor and a second vendor; the UE switching between a first geographic location or region and a second geographic location or region; the UE switching between a first serving cell and a second serving cell; a change in one or more channel conditions: a change in one or more features of the first model or the second model: or other conditions.

An NE-side model that is currently being used by the network entity may be compatible with the first UE-side model but may not be compatible with the second UE-side model. This may result in unsuccessful communications between the UE and the network entity when the UE switches from the first UE-side model to the second UE-side model.

Techniques and apparatuses are described herein for selecting models for compressed communication and switching between models for compressed communication. In some aspects, the UE may determine a condition and may switch from a first UE-side model to a second UE-side model. For example, the UE may switch from the first UE-side model to the second UE-side model based at least in part on determining that the first UE-side model is not able to be used for the condition and that the second UE-side model is able to be used for the condition, or based at least in part on determining that the second UE-side model will perform better (e.g., has a better performance indicator) for the condition than the first UE-side model. The UE may transmit a model identifier associated with the second UE-side model to the network entity. The network entity may receive the identifier associated with the second UE-side model, and may determine whether a current NE-side model is compatible with the second UE-side model. If the current NE-side model is compatible with the second UE-side model, the network entity may not switch to another NE-side model. Alternatively, if the current NE-side model is not compatible with the second UE-side model, the network entity may switch to another NE-side model that is compatible with the second UE-side model. Alternatively, even if the current NE-side model is compatible with the second UE-side model, the network entity may switch to another NE-side model that is preferred over the current NE-side model when the second UE-side model is in use.

In some other aspects, the UE may determine a condition and may transmit a condition identifier associated with the condition to the network entity. The network entity may identify an NE-side model that is able to be used for the condition and may selectively switch NE-side models based at least in part on the identified NE-side model. For example, the network entity may switch between models if a current NE-side model is not able to be used for the condition but may not switch models if the current NE-side model is able to be used for the condition. Alternatively, even if the current NE-side model is able to be used for the condition, the network entity may switch to another NE-side model that is preferred over the current NE-side model for the condition. The network identity may identify a UE-side model that is compatible with the NE-side model, and may transmit an identifier associated with the UE-side model. The UE may receive the identifier associated with the UE-side model and may switch to the identified UE-side model.

In some other aspects, the UE may determine a condition and may determine one or more UE-side models and/or one or more NE-side models that are able to be used for the condition. The UE may transmit one or more UE-side model identifiers respectively corresponding to the one or more UE-side models and/or one or more NE-side model identifiers respectively corresponding to the one or more NE-side models. The network entity may receive the UE-side model identifiers and/or the NE-side model identifiers, and may selectively switch to an NE-side model based at least in part on receiving the UE-side model identifiers and/or the NE-side model identifiers. In some aspects, the NE-side model to which the network entity switched is identified by one of the identifiers. For example, the network entity may switch from a first NE-side model to a second NE-side model, and may transmit an indication for the UE to switch to a UE-side model that is compatible with the second NE-side model. The UE may switch to the UE-side model based at least in part on receiving the indication from the network entity.

As described above, the UE or the network entity may switch models based at least in part on a condition and compatibility between the models. The UE may switch from a first UE-side model to a second UE-side model that is able to be used in association with a detected condition, and the network entity may switch from a first NE-side model that is not compatible with the second UE-side model to a second NE-side model that is compatible with the second UE-side model. This may reduce the number of missed or otherwise disrupted communications between the UE and the network entity.

Additionally, this may reduce unnecessary model switching by the UE and the network entity. For example, if the first NE-side model was compatible with the second UE-side model, the network entity may determine not to switch between the first NE-side model and the second NE-side model.

Additional details are described herein.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

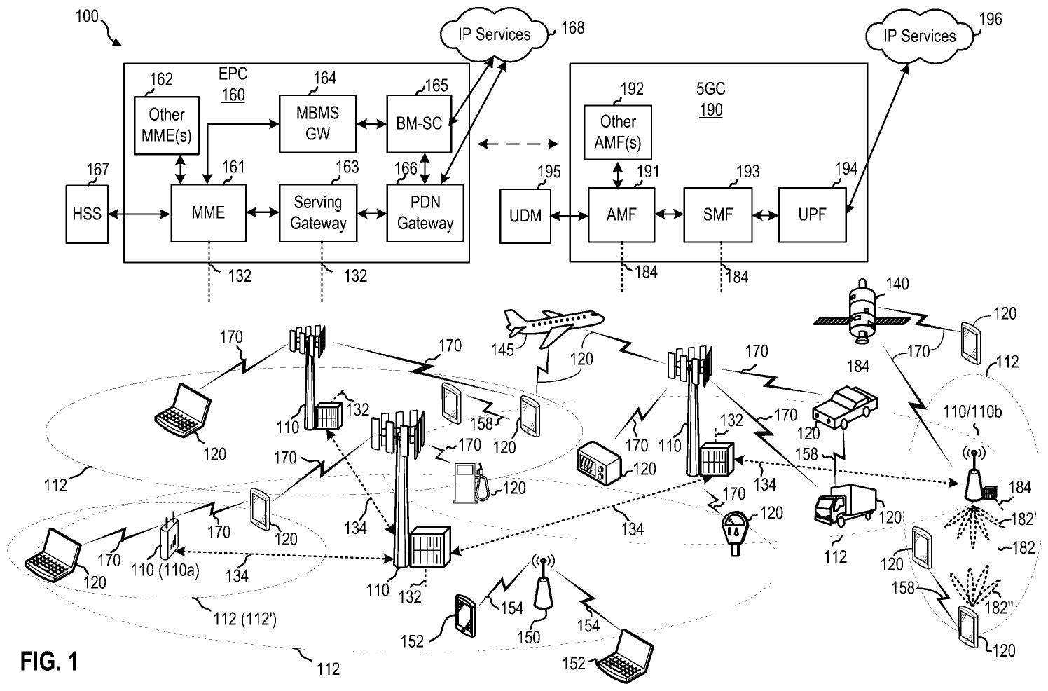

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 110), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 110, UEs 120, and one or more core networks, such as an Evolved Packet Core (EPC) 160 and 5G Core (5GC) 190, which interoperate to provide communications services over various communications links, including wired and wireless links.

FIG. 1 depicts various example UEs 120, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) device, always on (AON) device, edge processing device, or another similar device. A UE 120 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, or a handset, among other examples.

BSs 110 may wirelessly communicate with (e.g., transmit signals to or receive signals from) UEs 120 via communications links 170. The communications links 170 between BSs 110 and UEs 120 may carry uplink (UL) (also referred to as reverse link) transmissions from a UE 120 to a BS 110 and/or downlink (DL) (also referred to as forward link) transmissions from a BS 110 to a UE 120. The communications links 170 may use multiple-input and multiple-output (MIMO) antenna technology, including spatial multiplexing, beamforming, and/or transmit diversity in various aspects.

BSs 110 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. A BS 110 may provide communications coverage for a respective geographic coverage area 112, which may sometimes be referred to as a cell, and which may overlap in some cases (e.g., a small cell provided by a BS 110a may have a coverage area 112′ that overlaps the coverage area 112 of a macro cell). A BS may, for example, provide communications coverage for a macro cell (covering a relatively large geographic area), a pico cell (covering a relatively smaller geographic area, such as a sports stadium), a femto cell (covering a relatively smaller geographic area (e.g., a home)), and/or other types of cells.

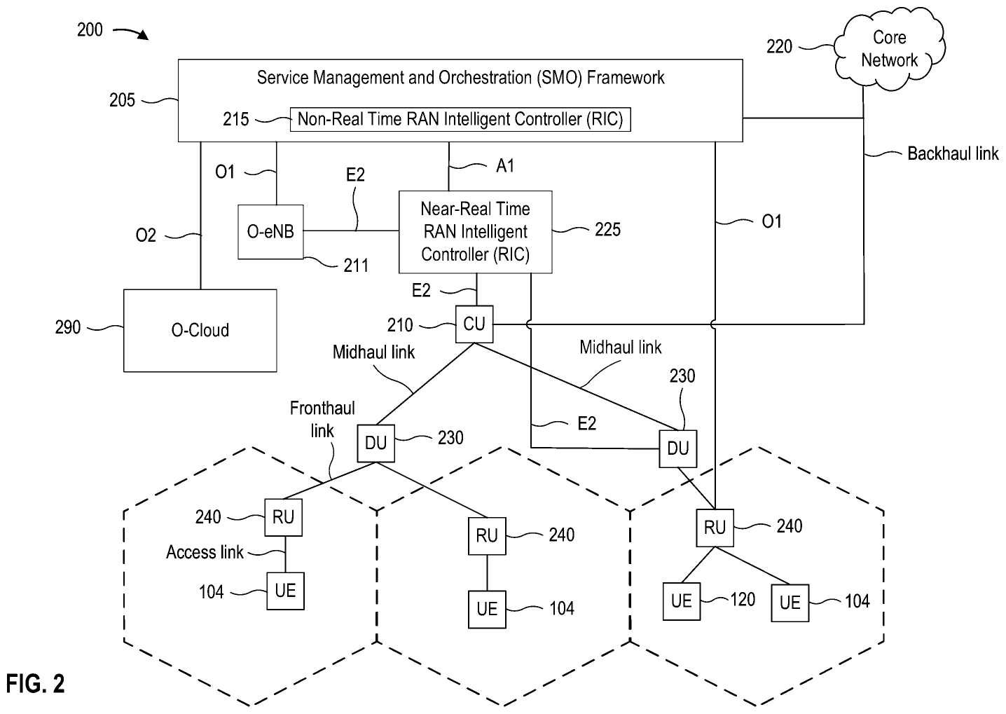

While BSs 110 are depicted in various aspects as unitary communications devices. BSs 110 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 110) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 110 within wireless communications network 100 may also be configured to support different radio access technologies, such as 3G, 4G, and or 5G. For example, BSs 110 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 110 configured for 5G (e.g., 5G NR or Next Generation RAN (NG-RAN)) may interface with 5GC 190 through second backhaul links 184. BSs 110 may communicate directly or indirectly (e.g., through the EPC 160 or 5GC 190) with each other over third backhaul links 134 (e.g., X2 interfaces), which may be wired or wireless.

Wireless communications network 100 may subdivide the electromagnetic spectrum into various classes, bands, channels, or other features. In some aspects, the subdivision is provided based at least in part on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52.600 MHz, which is sometimes referred to (interchangeably) as a “millimeter wave” (“mmW” or “mmWave”). A base station configured to communicate using mmWave or near mmWave radio frequency bands (e.g., a mmWave base station such as BS 110b) may utilize beamforming (e.g., as shown by 182) with a UE (e.g., 120) to improve path loss and range.

The communications links 170 between BSs 110 and, for example, UEs 120, may be through one or more carriers, which may have different bandwidths (e.g., 5 MHz, 10 MHz, 15 MHz, 20 MHz, 100 MHz, 400 MHz, and/or other bandwidths), and which may be aggregated in various aspects, Carriers may or may not be adjacent to each other. In some examples, allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 110b in FIG. 1) may utilize beamforming with a UE 120 to improve path loss and range, as shown at 182. For example, BS 110b and the UE 120 may each include a plurality of antennas, such as antenna elements, antenna panels, and/or antenna arrays to facilitate the beamforming. In some cases. BS 110b may transmit a beamformed signal to UE 120 in one or more transmit directions 182′. UE 120 may receive the beamformed signal from the BS 110b in one or more receive directions 182″. UE 120 may also transmit a beamformed signal to the BS 110b in one or more transmit directions 182″. BS 110b may also receive the beamformed signal from UE 120 in one or more receive directions 182′. BS 110b and UE 120 may then perform beam training to determine the best receive and transmit directions for each of BS 110b and UE 120. Notably, the transmit and receive directions for BS 110b may or may not be the same. Similarly, the transmit and receive directions for UE 120 may or may not be the same.

Wireless communications network 100 further includes a Wi-Fi access point (AP) 150 in communication with Wi-Fi stations (STAs) 152 via communications links 154 in, for example, a 2.4 GHz and/or 5 GHz unlicensed frequency spectrum.

Certain UEs 120 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 161, other MMEs 162, a Serving Gateway 163, a Multimedia Broadcast Multicast Service (MBMS) Gateway 164, a Broadcast Multicast Service Center (BM-SC) 165, and/or a Packet Data Network (PDN) Gateway 166, such as in the depicted example. MME 161 may be in communication with a Home Subscriber Server (HSS) 167. MME 161 is the control node that processes the signaling between the UEs 120 and the EPC 160. Generally, MME 161 provides bearer and connection management.

Generally, user Internet protocol (IP) packets are transferred through Serving Gateway 163, which itself is connected to PDN Gateway 166. PDN Gateway 166 provides UE IP address allocation as well as other functions. PDN Gateway 166 and the BM-SC 165 are connected to IP Services 168, which may include, for example, the Internet, an intranet, an IP Multimedia Subsystem (IMS), a Packet Switched (PS) streaming service, and/or other IP services.

BM-SC 165 may provide functions for MBMS user service provisioning and delivery. BM-SC 165 may serve as an entry point for content provider MBMS transmission, may be used to authorize and initiate MBMS Bearer Services within a public land mobile network (PLMN), and/or may be used to schedule MBMS transmissions. MBMS Gateway 164 may be used to distribute MBMS traffic to the BSs 110 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 191, other AMFs 192, a Session Management Function (SMF) 193, and a User Plane Function (UPF) 194. AMF 191 may be in communication with Unified Data Management (UDM) 195.

AMF 191 is a control node that processes signaling between UEs 120 and SGC 190. AMF 191 provides, for example, quality of service (QoS) flow and session management.

IP packets are transferred through UPF 194, which is connected to the IP Services 196, and which provides UE IP address allocation as well as other functions for 5GC 190. IP Services 196 may include, for example, the Internet, an intranet, an IMS, a PS streaming service, and/or other IP services.

In various aspects, a network entity or network node can be implemented as an aggregated base station, a disaggregated base station, a component of a base station, an integrated access and backhaul (IAB) node, a relay node, a sidelink node, or a transmission reception point (TRP), to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 120 via one or more radio frequency (RF) access links. In some implementations, the UE 120 may be simultaneously served by multiple RUs 240.

Each of the units (e.g., the CUS 210, the DUs 230, the RUs 240, as well as the Near-RT RICs 225, the Non-RT RICs 215 and the SMO Framework 205) may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as an RF transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over-the-air (OTA) communications with one or more UEs 120. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240, and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, artificial intelligence/machine learning (AI/ML) workflows including model training and updates, or policy-based guidance of applications features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

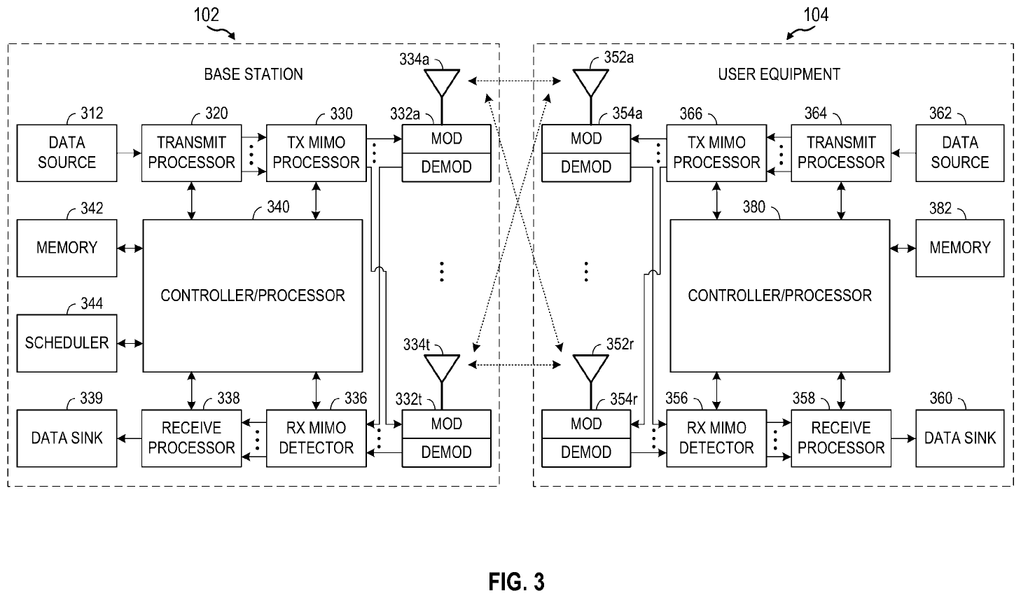

FIG. 3 depicts aspects of an example BS 110 and UE 120.

Generally, BS 110 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 110 may send and receive data between BS 110 and UE 120. BS 110 includes controller/processor 340, which may be configured to implement various functions described herein related to wireless communications.

Generally. UE 120 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 120 includes controller processor 380, which may be configured to implement various functions described herein related to wireless communications.

In regard to an example downlink transmission, BS 110 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 120 includes antennas 352a-352r that may receive the downlink signals from the BS 110 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 120 to a data sink 360, and provide decoded control information to a controller processor 380.

In regard to an example uplink transmission. UE 120 further includes a transmit processor 364 that may receive and process data (e.g., for the physical uplink shared channel (PUSCH)) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 110.

At BS 110, the uplink signals from UE 120 may be received by antennas 334a-t, processed by the demodulators in transceivers 332a-332t, detected by a MIMO detector 336 if applicable, and further processed by a receive processor 338 to obtain decoded data and control information sent by UE 120. Receive processor 338 may provide the decoded data to a data sink 339 and the decoded control information to the controller/processor 340. Memories 342 and 382 may store data and program codes for BS 110 and UE 120, respectively. Scheduler 344 may schedule UEs for data transmission on the downlink and/or uplink.

In various aspects, BS 110 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 120 may likewise be described as transmitting and receiving various types of data associated with the methods described herein. In these contexts. “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

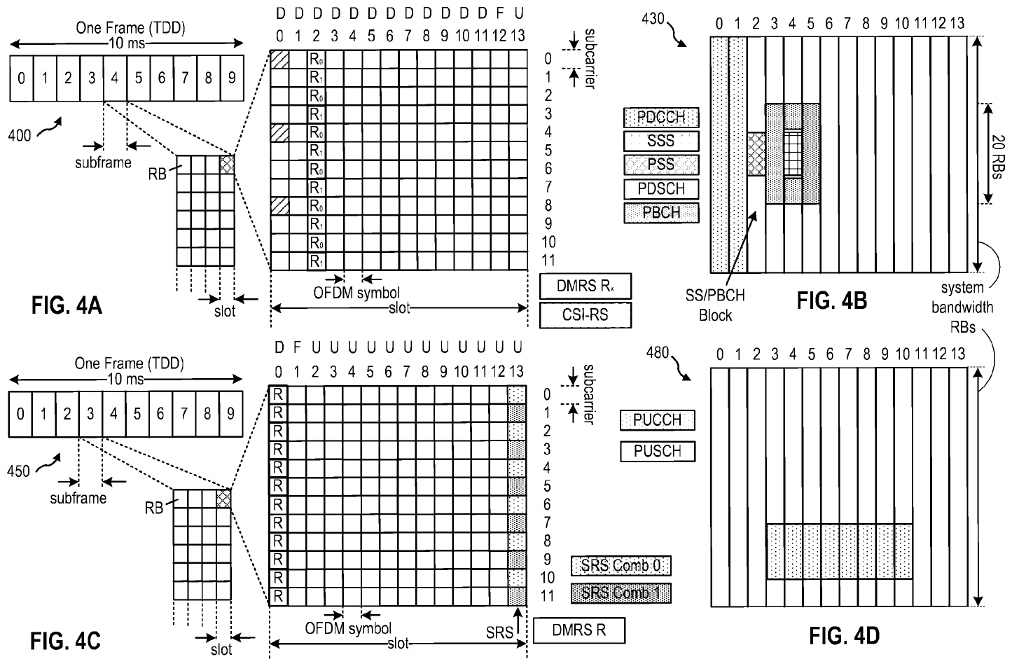

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL. U is UL, and F is flexible for use between DL/UL. UEs may be configured with a slot format through a received slot format indicator (SFI) (dynamically through DL control information (DCI), or semi-statically statically through RRC signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based at least in part on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols slot and 24 slots/subframe. The subcarrier spacing and symbol length/duration are a function of the numerology. The subcarrier spacing may be equal to 24×15 kHz, where u is the numerology 0 to 5. Accordingly, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RSs) for a UE (e.g., UE 120 of FIGS. 1 and 3). The RSs may include demodulation RSs (DMRSs) and/or channel state information reference signals (CSI-RSs) for channel estimation at the UE. The RSS may also include beam measurement RSs (BRSs), beam refinement RSs (BRRSs), and/or phase tracking RSs (PT-RSs).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based at least in part on the physical layer identity and the physical layer cell identity group number, the UE can determine a physical cell identifier (PCI). Based at least in part on the PCI, the UE can determine the locations of the aforementioned DMRSs. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and or paging messages.

As illustrated in FIG. 4C, some of the REs carry DMRSs (indicated as R for one particular configuration, but other DMRS configurations are possible) for channel estimation at the base station. The UE may transmit DMRSs for the PUCCH and DMRSs for the PUSCH. The PUSCH DMRSs may be transmitted, for example, in the first one or two symbols of the PUSCH. The PUCCH DMRSs may be transmitted in different configurations depending on whether short or long PUCCHs are transmitted and depending on the particular PUCCH format used. UE 120 may transmit sounding reference signals (SRSs). The SRSs may be transmitted, for example, in the last symbol of a subframe. The SRSs may have a comb structure, and a UE may transmit SRSs on one of the combs. The SRSs may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Selecting Models for Compressed Communication and Switching Between Models for Compressed Communication

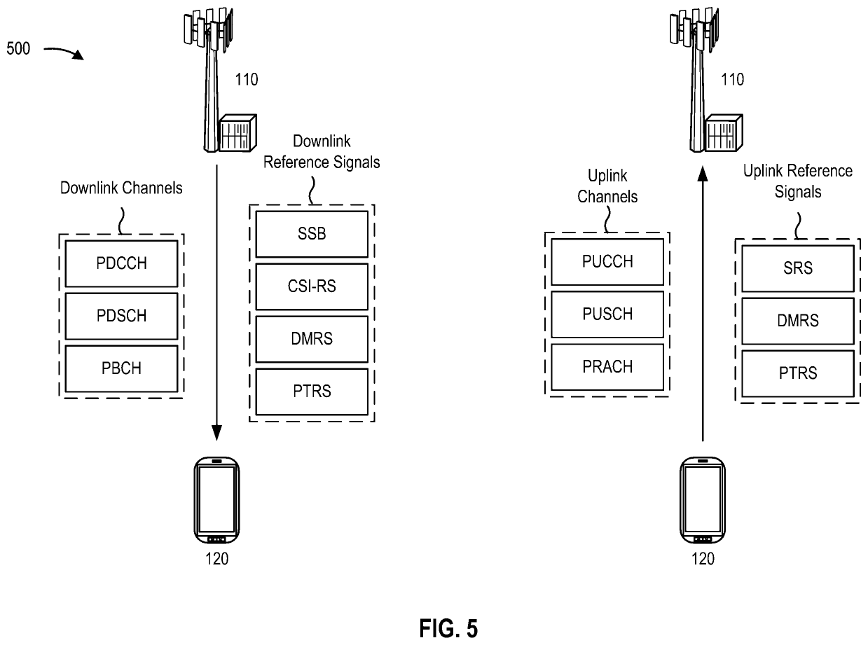

FIG. 5 is a diagram illustrating an example 500 of physical channels and reference signals in a wireless network, in accordance with the present disclosure. As shown in FIG. 5, downlink channels and downlink reference signals may carry information from a network entity 110 to a UE 120, and uplink channels and uplink reference signals may carry information from a UE 120 to a network entity 110.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include a synchronization signal block (SSB), a channel state information (CSI) reference signal (CSI-RS), a demodulation reference signal (DMRS), a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. In some aspects, the network entity 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network entity 110 may configure a set of CSI-RSs for the UE 120, and the UE 120 may measure the configured set of CSI-RSs. Based at least in part on the measurements, the UE 120 may perform channel estimation and may report channel estimation parameters to the network entity 110 (e.g., in a CSI report), such as a channel quality indicator (CQI), a precoding matrix indicator (PMI), a CSI-RS resource indicator (CRI), a layer indicator (LI), a rank indicator (RI), or a reference signal received power (RSRP), among other examples. The network entity 110 may use the CSI report to select transmission parameters for downlink communications to the UE 120, such as a number of transmission layers (e.g., a rank), a precoding matrix (e.g., a precoder), a modulation and coding scheme (MCS), or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH. PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based at least in part on signals transmitted by the network entity 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring network entities in order to perform OTDOA-based positioning. Accordingly, the UE 120 may receive a PRS from multiple cells (e.g., a reference cell and one or more neighbor cells), and may report a reference signal time difference (RSTD) based at least in part on OTDOA measurements associated with the PRSs received from the multiple cells. In some aspects, the network entity 110 may then calculate a position of the UE 120 based at least in part on the RSTD measurements reported by the UE 120.

An SRS may carry information used for uplink channel estimation, which may be used for scheduling, link adaptation, precoder selection, or beam management, among other examples. The network entity 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network entity 110 may measure the SRSs, may perform channel estimation based at least in part on the measurements, and may use the SRS measurements to configure communications with the UE 120.

In some cases, the UE 120 and the network entity 110 may be configured with one or more models, such as artificial intelligence (AI) models and/or machine learning (ML) models. The UE 120 and the network entity 110 may use the models for communicating information such as refence signal (e.g., CSI-RS) measurements. Additional details regarding these features are described below.

As indicated above, FIG. 5 is provided as an example. Other examples may differ from what is described with regard to FIG. 5.

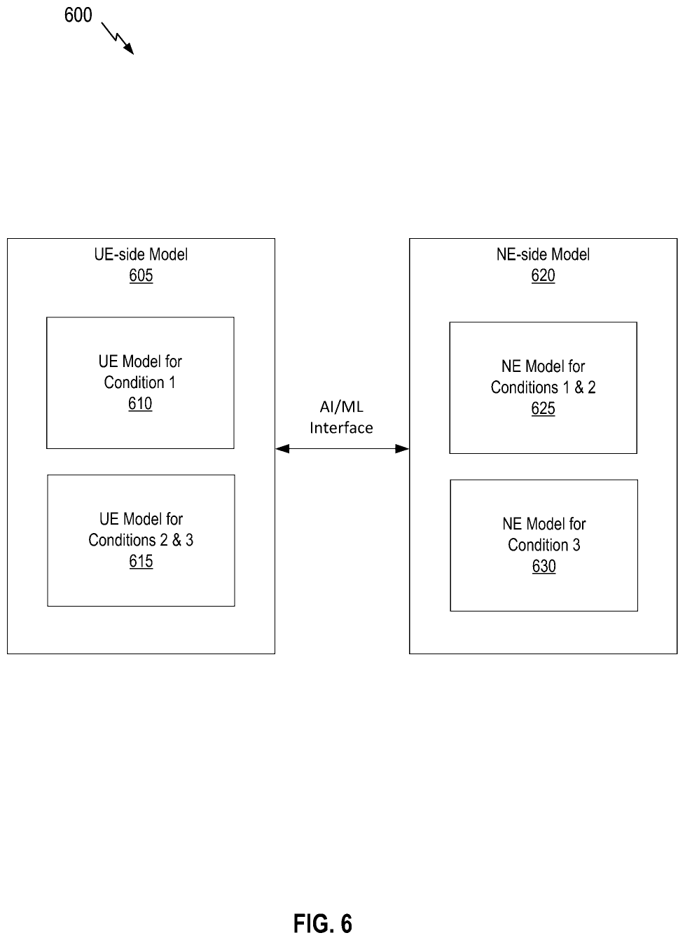

FIG. 6 is a diagram illustrating an example of machine learning models, in accordance with the present disclosure.

In some cases, the UE 120 and the network entity 110 may use models, such as AI or ML models, for performing one or more functions. For example, the AI/ML models may be used for communicating compressed information. A communication that includes compressed information may be referred to herein as a compressed communication. The UE 120 and the network entity 110 may communicate information associated with the model using an interface such as an AI/ML-based air interface. In one example, the information may be compressed information associated with one or more reference signal measurements. In one example, the UE 120 may determine CSI for transmitting to the network entity 110. The UE 120 may use a model, such as a neural network ML model, to derive a compressed representation of the CSI for transmitting to the network entity 110. The network entity 110 may receive the compressed representation of the CSI and may use another model, such as another neural network model, to reconstruct the CSI from the compressed representation. For the reconstruction to be accurate, the UE-side model and the NE-side model may need to be trained in a collaborative manner so that the compressed representation generated by the UE-side model is interpreted and decoded correctly by the NE-side model. If the network entity is able to receive the communication and accurately decode the channel information using an NE-side model, the UE-side model and the NE-side model may be considered to be compatible. Alternatively, if the network entity is not able to accurately decode the channel information included within the communication, the UE-side model and the NE-side model may be considered incompatible.

In some cases, an AI/ML model may be used in different conditions or scenarios. For example, the model may be used for an indoor UE condition and/or an outdoor UE condition. In another example, the model may be used for a line-of-sight (LOS) UE condition and/or a non-line-of-sight (NLOS) UE condition. In another example, the model may be used for a UE associated with a first vendor and/or may be used for a UE associated with a second vendor. In another example, the model may be used in a first geographic location or region and/or may be used in a second geographic location or region. In another example, the model may be used for a UE associated with a first serving cell and/or may be used for a UE associated with a second serving cell. In another example, the model may be used in one or more channel conditions, such as certain delay spread conditions or signal-to-noise ratio (SNR) conditions. In another example, the model may be used with one or more model feature conditions, such as a model size condition or a mode category condition. Other conditions may be considered.

In some cases, a model that is trained using data samples associated with a particular condition may not perform well if the model is used for another condition. If the model is trained using data samples from many conditions, the model may work well under the many conditions and/or other conditions. However, this may result in the model being large and computationally complex. This may be problematic since the model may be too large or complex to be used by the UE 120 and/or the network entity 110.

In some cases, the UE-side model may be condition-specific while the NE-side model may be trained with data samples associated with multiple conditions. In this case, the NE-side model may be compatible with many different condition-specific UE-side models. In some other cases, the NE-side model may be condition-specific while the UE-side model may be trained with data samples associated with multiple conditions. In this case, the UE-side model may be compatible with many different condition-specific NE-side models.

As shown in the example 600, a UE-side model 605 may include a UE model for condition 1 610 and a UE model for conditions 2 and 3 615. An NE-side model 620 may include a NE model for conditions 1 and 2 625 and a NE model for condition 3 630. In this example, the UE model for condition 1 610 may be condition-specific while the UE model for conditions 2 and 3 615 may be trained with data samples associated with multiple conditions. Similarly, the NE model for conditions 1 and 2 625 may be trained with data samples associated with multiple conditions while the NE model for condition 3 may be condition-specific.

In some cases, there may be a need to identify the current condition and to use a model that is appropriate to that condition. Once the condition is identified by the UE 120, there may be a need for a mechanism for the UE 120 to inform the network entity 110 about the condition so that the network entity 110 can respond accordingly. There may also be a need to define the response and actions from the network entity 110 to such an indication. In one example, the UE 120 may be using the UE model for condition 1 610 and the network entity 110 may be using the NE model for conditions 1 and 2 625. If the UE 120 detects a condition 2, such as the UE 120 moving to an outside condition, the UE 120 may need to switch from the UE model for condition 1 610 to the UE model for conditions 2 and 3 615. However, the network entity 110 may not need to switch models since the NE model for conditions 1 and 2 625 may be able to be used for condition 2. At another time, the UE 120 may detect a condition 3, such as the UE moving to a particular geographic location or region associated with condition 3. The UE 120 may not need to switch models since the UE model for conditions 2 and 3 615 is able to be used for condition 3. However, the network entity 110 may need to switch models from the NE model for conditions 1 and 2 625 to the NE model for condition 3 630.

As described above, the UE 120 or the network entity 110 may switch models based at least in part on a condition. This may result in disrupted communications between the UE 120 and the network entity 110. Using the techniques and apparatuses described herein, the UE 120 and the network entity 110 may communicate condition information and/or model information to ensure that the UE-side model and the NE-side model are compatible. This may improve communications between the UE 120 and the network entity 110 by reducing a likelihood that the UE 120 and/or the network entity 110 are not able to decode a communication due to model incompatibility.

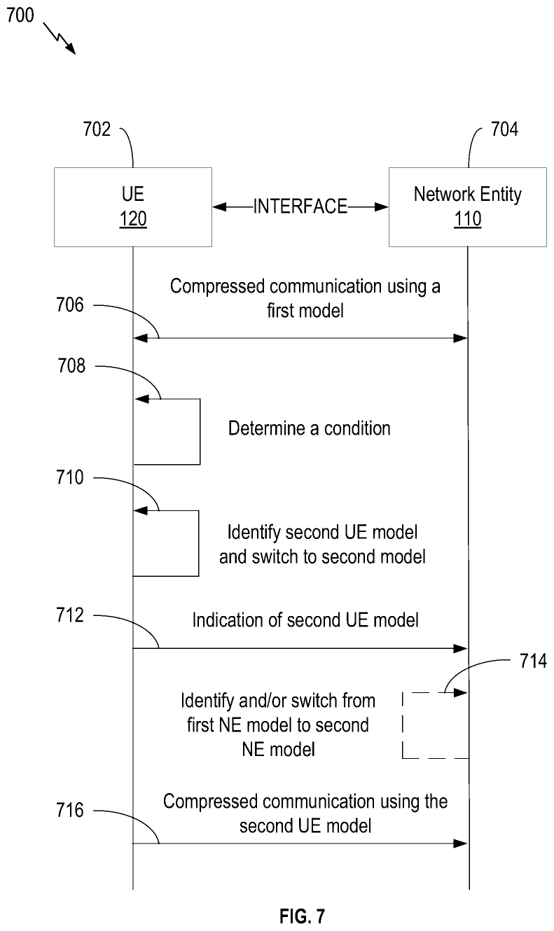

In some aspects, the UE 120 may determine a condition and may switch from a first UE-side model to a second UE-side model. For example, the UE 120 may switch from the first UE-side model to the second UE-side model based at least in part on determining that the first UE-side model is not able to be used for the condition and that the second UE-side model is able to be used for the condition, or based at least in part on determining that the second UE-side model has a better performance indicator for the condition than the first UE-side model has for the condition. The UE 120 may transmit a model identifier associated with the second UE-side model to the network entity 110. The network entity 110 may receive the identifier associated with the second UE-side model, and may determine whether a current NE-side model is compatible with the second UE-side model. If the current NE-side model is compatible with the second UE-side model, the network entity 110 may not switch to another NE-side model. Alternatively, if the current NE-side model is not compatible with the second UE-side model, the network entity 110 may switch to another NE-side model that is compatible with the second UE-side model. Additional details regarding these features are described below in connection with FIG. 7.

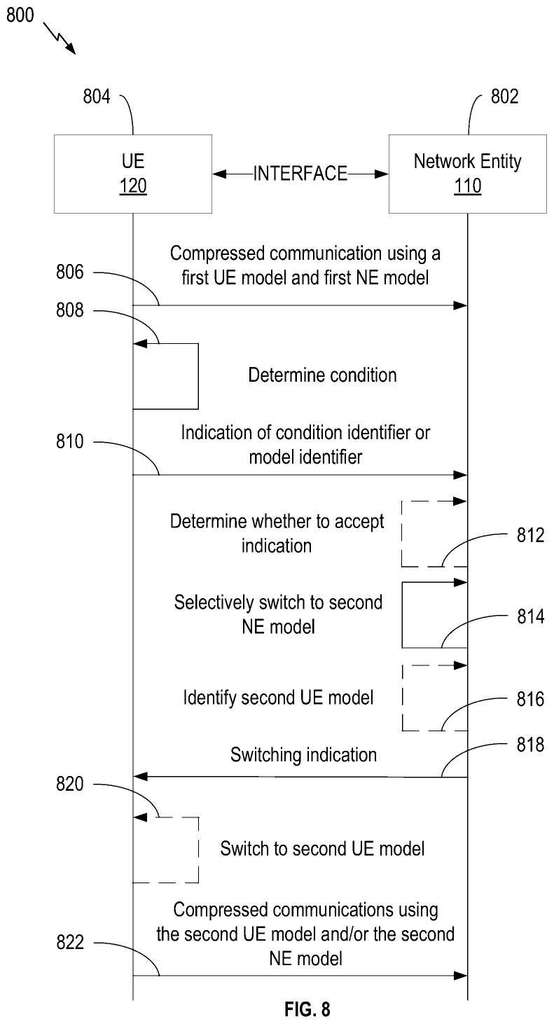

In some other aspects, the UE 120 may determine a condition and may transmit a condition identifier associated with the condition to the network entity 110. The network entity 110 may identify an NE-side model that is able to be used for the condition and may selectively switch NE-side models based at least in part on the identified NE-side model. For example, the network entity 110 may switch between models if a current NE-side model is not able to be used for the condition but may not switch models if the current NE-side model is able to be used for the condition. The network entity 110 may identify a UE-side model that is compatible with the NE-side model, and may transmit an identifier associated with the UE-side model. The UE 120 may receive the identifier associated with the UE-side model and may switch to the identified UE-side model. In some other aspects, the UE 120 may determine a condition and may determine one or more UE-side models and/or one or more NE-side models that are able to be used for the condition. The UE 120 may transmit one or more UE model identifiers respectively corresponding to the one or more UE-side models and/or one or more NE model identifiers respectively corresponding to the one or more NE-side models. The network entity 110 may receive the UE model identifiers and/or the NE model identifiers and may selectively switch to an NE-side model based at least in part on receiving the UE model identifiers and or the NE model identifiers. For example, the network entity 110 may switch from a first NE-side model to a second NE-side model, and may transmit an indication for the UE to switch to a UE-side model that is compatible with the second UE-side model. The UE 120 may switch to the UE-side model based at least in part on receiving the indication from the network entity 110. Additional details regarding these features are described below in connection with FIG. 8.

As indicated above, FIG. 6 is provided as an example. Other examples may differ from what is described with regard to FIG. 6.

### Aspects Related to Machine Learning Channel State Feedback Channel Classification

In some cases, channel state feedback (CSF) may be codebook-based CSF. In this case, the UE 120 may calculate a precoder and may map the precoder to a CSF payload, and the network entity 110 may reconstruct the precoder based at least in part on the CSF payload. Equations or other indicators for reconstructing the precoder based at least in part on the CSF payload may be configured in the network entity 110. In some cases, the CSF ML-based. In this case, the UE 120 may compress the precoder and may map an output of the compressing operation to a CSF payload, and the network entity 110 may reconstruct the precoder based at least in part on the CSF payload.

In some cases, the UE 120 and the network entity 110 may use a CSI compression neural network (e.g., an encoder) and CSI reconstruction neural network (e.g., a decoder). A universal encoder/decoder may cover a larger number of channel variations. However, for each channel variation, the neural network may not be optimal. In contrast, a specialized encoder/decoder may only cover specific channel variations. For these channel variations, the neural network may be optimal. However, the UE 120 and the network entity 110 may not be configured with information for training a specialized encoder/decoder. Additionally, the UE 120 and/or the network entity 110 may need to determine a tradeoff between performance and channel variation coverage.

In some aspects, a channel classification neural network may be configured to determine channel classifications for an encoder/decoder (such as the specialized encoder/decoder). In some aspects, the channel classification may divide all channel inputs into multiple clusters, and multiple encoders/decoders may be used (e.g., instead of a single encoder/decoder for each channel). In some aspects, multiple encoders (or an encoder with a cluster indicator as an input), and a single decoder, may be used. For each input, a channel classification operation can output a cluster indicator. The corresponding encoder decoder can be used for generating the cluster indicator. For each input, the channel classification operation can also output a distribution indicator. In this case, no encoder/decoder may be needed. The determination of the current condition may be based on the cluster indicator.

In some aspects, data sharing may be performed for sequential training. If the encoders/decoders are trained separately, starting with UE-side training or NE-side training, the UE 120 and the network entity 110 may share training dataset(s). In one example, each encoder/decoder output may be treated as an independent neural network. An encoder output/decoder output may be shared for each encoder/decoder pair, and the channel classification may be transparent to the network entity 110. In another, multiple encoders/decoders may be treated as an encoder/decoder group. An encoder/decoder output may be shared with the group (e.g., cluster), and the channel classification may not be transparent to the network entity 110. In another, for multiple encoders but a single (universal) decoder, multiple encoder outputs and a single decoder output may be shared between the UE 120 and the network entity 110.

In some aspects, the UE 120 and the network entity 110 may communicate cluster indicator signaling. Since the UE 120 may use a different encoder than the network entity 110, a single neural network ID (NNID) may not be enough to align the encoder/decoder pair. In one example, multiple NNIDs may be used. Each NNID may correspond to a single encoder. The network entity may transmit an indication to the UE 120 that indicates the NNID that is to be used. In this case, channel classification may be performed at the network entity 110. If UE reporting is enabled (e.g., allowed), the UE 120 may report the NNID and/or may report an out-of-distribution (OOD) message to the network entity 110. In another example, a single NNID and one or more sub-NNIDs may be used. An NNID may correspond to a main NNID and one or more sub NNIDs. In some aspects, the network entity 110 may indicate the main NNID to the UE 120. The UE 120 may identify the sub-NNID based at least in part on the main NNID. The UE 120 may transmit an indication of the sub-NNID to the network entity 110 or may transmit an OOD message. Channel classification may be performed at the UE 120. The main NNID may correspond to a network entity 110 antenna setting or a network entity 110 encoder. In some other aspects, the network entity 110 may indicate both the NNID and the sub-NNID to the UE 120. For example, the network entity 110 may indicate one or more sub-NNIDs and/or a sub-NNID list. The UE 120 may report the sub-NNID based at least in part on the configured sub-NNID. If the UE 120 detects an OOD, a sub-NNID that is used for OOD may be reported. In some aspects, the sub-NNID list may be reported using an RRC message.

In some aspects, the UE 120 may be configured with information that enables the UE 120 to transmit the NNID, the sub-NNID, and/or the OOD. In some aspects, a CSI report may enable the UE 120 to transmit the NNID report. For example, a reportQuantity indicator may be used to enable the UE 120 to transmit the NNID report. In another example, the CSI report may enable the UE 120 to transmit the sub-NNID report. Additionally, or alternatively, a new codebook type may enable the UE 120 to transmit the sub-NNID report. In some aspects, the NNID report and the OOD report may be associated with different CSF payloads (e.g., similar to PMI and CQI). In some aspects, the NNID report and the OOD report may be included in the same CSF payload. In this case, a mapping may be used to map the payload information and the NNID/OOD information. An example mapping is shown in Table 1:

TABLE 1

| | Sub-NNID | OOD Flag |
|---|---|---|
| 0 | N/A | 1 |
| 1 | 0 | 0 |
| 2 | 1 | 0 |
| 3 | 2 | 0 |

In some aspects, if OOD is reported, the other CSF payload may be a dummy payload. For example, the other CSF payload may be all zeros. In some aspects, the other payload may be the neural network payload. The other payload may be the neural network payload even if the network entity 110 is not able to decode the neural network payload. In this case, the UE 120 may use the best sub-encoder or may use a default sub-encoder. The default sub-encoder may be configured by the network entity 110. In some aspects, the other CSF payload may be based at least in part on TypeI, Type II, or eTypeII fallback information. In this case, zero padding may be used if the payload size does not match. The fallback information may correspond to a legacy CSF. For example, if OOD is detected and/or reported, the UE 120 may follow the pre-defined mapping to determine the fallback CSF. An example of this mapping is shown in Table 2.

TABLE 2

| NNID | eTypeII |
|---|---|
| 0 | PC1 |
| 1 | PC2 |
| 2 | PC3 |
| 3 | PC4 |

In some aspects, the NNID/OOD report may be included in CSI part 1, while the encoder output (latent) may be included in CSI part 2. This may allow each NNID to have its own latency size. In some aspects, the UE 120 may drop the CSI part 2. For example, the UE 120 may drop the CSI part 2 if the OOD is indicated in the CSI part 1.

### Example Operations of Entities in a Communications Network

FIG. 7 depicts a process flow 700 for communications in a network between a UE 702 and a network entity 704. In some aspects, the UE 702 may be an example of the UE 702 depicted and described with respect to FIGS. 1 and 3. Similarly, the network entity 704 may be an example of the BS 704 depicted and described with respect to FIGS. 1 and 3 or a disaggregated base station depicted and described with respect to FIG. 2. However, in other aspects, UE 702 may be another type of wireless communications device and the network entity 704 may be another type of network entity or network node, such as those described herein.

As shown by reference number 706, the UE 702 and the network entity 704 may communicate compressed information using a first model. For example, the UE 702 may obtain a reference signal measurement (such as a CSI-RS measurement), may generate a compressed communication (using the first UE model) that includes the reference signal measurement, and may transmit the compressed communication. The network entity 704 may receive the compressed communication and may decode the compressed communication using a first NE model. The first UE model and the first NE model may be compatible. For example, the network entity 704 may be able to receive the compressed communication generated by the first UE model and to accurately decode the information included in the compressed communication using the first NE model.

As shown by reference number 708, the UE 702 may determine a condition. The condition may include, for example, one or more of the conditions described in connection with FIG. 6. The UE 702 may determine the condition based at least in part on the reference signal measurement and/or based at least in part on one or more rules, such as one or more threshold-based rules that can be applied to one or more channel parameters. For example, the UE 702 may determine the condition based at least in part on a delay spread satisfying a delay spread threshold, an SNR satisfying an SNR threshold, or a Doppler spread satisfying a Doppler spread threshold, among other examples. In some aspects, a condition classifier (e.g., a scenario classifier) may be configured to determine the one or more rules and/or apply the one or more rules. The condition classifier may be an ML model that has been trained to identify the condition based at least in part on reference signal measurement, such as the CSI.

As shown by reference number 710, the UE 702 may identify a second UE model for transmitting compressed communications based at least in part on the condition. For example, the UE 702 may identify a second UE model that is able to be used for the condition. In one example, the condition may include an outdoor condition, and determining the condition may include determining that the UE 702 has moved to an outdoor condition. In this case, the UE 702 may identify a second UE model that is able to be used for the outdoor condition. In another example, the condition may be associated with a particular geographic location or region, and determining the condition may include determining that the UE 702 has moved to the particular geographic location or region. In this case, the UE 702 may identify a second UE model that is able to be used in the particular geographic location or region. The UE 702 may switch from the first UE model to the second UE model based at least in part on determining that the first UE model is not able to be used for the condition and that the second UE model is able to be used for the condition. In another example, the UE 702 may switch from the first UE model to the second UE model based at least in part on determining that the second UE model has a better performance indicator for the condition than the first UE model has for the condition. In some aspects, the UE 702 may not switch from the first UE model to the second UE model based at least in part on determining that the first UE model is able to be used for the condition.

In some aspects, the UE 120 may monitor a plurality of models that includes at least one inactive model. The UE 120 may detect the condition or another condition based at least in part on monitoring at least one active model of the plurality of models and the at least one inactive model of the plurality of models. The UE 120 may switch to a third model of the plurality of models based at least in part on detecting the condition or the other condition. For example, the UE 120 may be configured with a model for condition 1 that is currently active, and a model for condition 2 that is currently inactive. The UE 120 may determine whether it is in condition 1 or condition 2 based on monitoring the performance of both models. For example, if the model for condition 2 performs better than the model for condition 1, then the condition may be determined to be condition 2.

As shown by reference number 712, the UE 702 may transmit, and the network entity 704 may receive, an identifier associated with the second UE model. The UE 702 and/or the network entity 704 may be configured with a plurality of model identifiers corresponding to respective models, such as UE model identifiers corresponding to UE models and NE model identifiers corresponding to NE models. In some aspects, transmitting the identifier associated with the second UE model may include transmitting an index that indicates the second UE model.

As shown by reference number 714, the network entity 704 may selectively identify a second NE model and/or may selectively switch from the first NE model to the second NE model based at least in part on receiving the identifier associated with the second UE model. In some aspects, the network entity 704 may determine whether the first NE side model is compatible with the second UE side model. If the network entity 704 determines that the first NE model is compatible with the second UE model, the network entity 704 may determine not to identify and/or switch to the second NE model. For example, if the network entity 704 determines that the first NE model is able to accurately decode information that is generated by the second UE model, the network entity 704 may determine not to identify and/or switch to the second NE model. Alternatively, if the network entity 704 determines that the first NE model is not compatible with the second UE model, the network entity 704 may identify the second NE model and/or may switch to the second NE model. For example, if the network entity 704 determines that the first NE model is not able to accurately decode information that is generated by the second UE model, the network entity 704 may determine to identify the second NE model and/or to switch to the second NE model.

As shown by reference number 716, the UE 702 and the network entity 704 may perform compressed communications. The UE 702 may perform the compressed communications using the second UE model. For example, the UE 702 may compress (e.g., encode) information such as reference signal measurement information using the second UE model. The network entity 704 may perform the compressed communications using the first NE model or the second NE model. For example, the network entity 704 may perform the compressed communications using the first NE model based at least in part on determining that the first NE model is compatible with the second UE model. In this case, the network entity 704 may receive the compressed communication from the UE 702 that is using the second UE model and may decode the compressed information using the first NE model. Alternatively, the network entity 704 may perform the compressed communications using the second NE model based at least in part on determining that the first NE model is not compatible with the second UE model and based at least in part on switching to the second NE model. In this case, the network entity 704 may receive the compressed communication from the UE 702 that is using the second UE model and may decode the compressed information using the second NE model.

As indicated above, FIG. 7 is provided as an example. Other examples may differ from what is described with regard to FIG. 7.

FIG. 8 depicts a process flow 800 for communications in a network between a UE 802 and a network entity 804. In some aspects, the UE 802 may be an example of the UE 802 depicted and described with respect to FIGS. 1 and 3. Similarly, the network entity 804 may be an example of the BS 804 depicted and described with respect to FIGS. 1 and 3 or a disaggregated base station depicted and described with respect to FIG. 2. However, in other aspects, UE 802 may be another type of wireless communications device and the network entity 804 may be another type of network entity or network node, such as those described herein.

As shown by reference number 806, the UE 802 and the network entity 804 may perform compressed communications. For example, the UE 802 may obtain a reference signal measurement (such as a CSI-RS measurement), may generate a compressed communication (using the first UE model) that includes the reference signal measurement, and may transmit the compressed communication. The network entity 804 may receive the compressed communication and may decode the compressed communication using a first NE model. The first UE model and the first NE model may be compatible. For example, the network entity 804 may be able to receive the compressed communication generated by the first UE model and to accurately decode the information included in the compressed communication using the first NE model.

As shown by reference number 808, the UE 802 may determine a condition. The condition may include, for example, one or more of the conditions described in connection with FIG. 6. The UE 802 may determine the condition based at least in part on the reference signal measurement and/or based at least in part on one or more rules, such as one or more threshold-based rules that can be applied to one or more channel parameters. For example, the UE 802 may determine the condition based at least in part on a delay spread satisfying a delay spread threshold, an SNR satisfying an SNR threshold, or a Doppler spread satisfying a Doppler spread threshold, among other examples. In some aspects, a condition classifier (e.g., a scenario classifier) may be configured to determine the one or more rules and/or apply the one or more rules. The condition classifier may be an ML model that has been trained to identify the condition based at least in part on reference signal measurement, such as the CSI.

As shown by reference number 810, the UE 802 may transmit an indication of a condition identifier or a model identifier. The UE 802 may determine a condition identifier associated with the condition. For example, the UE 802 and the network entity 804 may be configured with a plurality of condition identifiers associated with a plurality of respective conditions. The UE 802 may determine an identifier corresponding to the condition based at least in part on the plurality of condition identifiers stored at the UE 802, and may transmit the condition identifier to the network entity 804. The network entity 804 may receive the condition identifier and may identify the condition based at least in part on the plurality of condition identifiers stored at the network entity 804. In some aspects, the network entity 804 may configure the UE 802 with a list of conditions, and the UE 802 may indicate the condition using an index that is included in the list of conditions. In some aspects, the indication of the condition may indicate a plurality of condition, where one or more of the conditions are associated with a confidence indicator. For example, the UE 802 may transmit two condition identifiers, where a first condition identifier includes a first confidence indicator (e.g., high confidence) and a second condition indicator includes a second confidence indicator (e.g., low confidence).

In some aspects, the UE 802 may determine a UE model identifier. The UE 802 may determine the UE model identifier based at least in part on a corresponding UE model that is able to be used for the condition. In one example, the UE model may correspond to the first UE model that is currently being used by the UE 802. In this example, the UE 802 may determine that the first UE model is able to be used for the condition, and may transmit an indication of the first UE model to the network entity 804. In another example, the UE model may correspond to a second UE model that is not currently being used by the UE 802. In this example, the UE 802 may determine that the first UE model is not able to be used for the condition and that the second UE model is able to be used for the condition, or may determine that the second UE model has a better performance indicator for the condition than the first UE model has for the condition, and may transmit the indication of the second UE model to the network entity 804. In some aspects, the network entity 804 may transmit information to the UE 802 that indicates one or more rules for selecting the second UE model. For example, the one or more rules may indicate for the UE 802 to select a UE model that is compatible with a currently used NE model (e.g., to avoid model switching by the network entity 804).

In some aspects, the UE 802 may determine a second NE model and/or an identifier associated with the second NE model. The UE 802 may determine the second NE model based at least in part on the condition. In some aspects, the network entity 804 may transmit information or rules (such as a lookup table) that indicate how the UE 802 is to select the NE model based at least in part on the condition. The UE 802 may transmit the identifier associated with the second NE model based at least in part on determining a second NE model that is able to be used for the condition.

In some aspects, the network entity 804 may transmit, and the UE 802 may receive, one or more reporting rules for transmitting the condition identifier and/or the model identifier (the UE model identifier or the NE model identifier). For example, not all condition changes may need to be conveyed to the network entity 804, such as if a current NE side model is able to be used for many conditions that include the condition. In some aspects, the one or more reporting rules may indicate one or more conditions for which the UE 802 is to transmit condition identifiers and/or model identifiers. In some other aspects, the one or more reporting rules may indicate one or more conditions for which the UE 802 is not to transmit condition identifiers and/or model identifiers

As shown by reference number 812, the network entity 804 may determine whether to accept the indication received from the UE 802. For example, the network entity 804 may determine whether to accept the indication, that includes the condition identifier or the model identifier, which suggests that the UE 802 and/or the network entity 804 are to perform model switching. In some aspects, the network entity 804 may determine whether to accept the indication from the UE 802 based at least in part on implementation information or compatibility information. For example, the network entity 804 may not initiate a model selection or model switching procedure at the network entity 804 based at least in part on a processing delay being greater than a processing delay threshold. In some aspects, the network entity 804 may only accept the indication based at least in part on the second UE model included in the model indication being compatible with a NE model that is currently being used by the network entity 804. If the second UE model is not compatible with the NE model that is currently being used by the network entity 804, the network entity 804 may not accept the model identifier, for example, to avoid a switching operation at the network entity 804.

As shown by reference number 814, the network entity 804 may identify a second NE model and/or may switch to the second NE model. In some aspects, the network entity 804 may identify the second NE model based at least in part on the model information. For example, the network entity 804 may receive the model information that indicates the second NE model and may switch from the first NE model to the second NE model based at least in part on the model information. In another example, the network entity 804 may receive the model information that indicates the second UE model and may switch from a first NE model that is not compatible with the second UE model to a second NE model that is compatible with the second UE model. In some aspects, the network entity 804 may identify the second NE model based at least in part on the condition identifier. For example, the network entity 804 may receive the condition identifier that indicates the condition and may switch from the first NE model that is not able to be used for the condition to the second NE model that is able to be used for the condition.

As shown by reference number 816, the network entity 804 may identify a second UE model. In some aspects, the network entity 804 may identify the second UE model based at least in part on the model information. For example, the network entity 804 may receive the model information from the UE 802 that indicates the second UE model and may determine that the UE 802 should switch from the first UE model to the second UE model. The network entity 804 may determine that the UE 802 should switch from the first UE model to the second UE model based at least in part on the second UE model being compatible with a current NE model, such as the first NE model (if the network entity does not switch from the first NE model to the second NE model) or the second NE model (if the network entity switches from the first NE model to the second NE model). In some aspects, the network entity 804 may identify the second UE model based at least in part on the condition identifier. For example, the network entity 804 may receive the condition identifier that indicates the condition and may determine the second UE model based at least in part on determining that the second UE model is able to be used for the condition associated with the condition identifier.

As shown by reference number 818, the network entity 804 may transmit, and the UE 802 may receive, a switching indication. The switching indication may be an indication that the UE 802 should switch to the second UE model, and may include an identifier associated with the second UE model. The network entity 804 may transmit the switching indication based at least in part on determining the second UE model and/or an identifier associated with the second UE model.

As shown by reference number 820, the UE 802 may switch to the second UE model. The UE 802 may switch to the second UE model based at least in part on receiving the switching indication from the network entity 804.

As shown by reference number 822, the UE 802 and the network entity 804 may perform compressed communications. The UE 802 may perform the compressed communications using the first UE model based at least in part on the UE 802 or the network entity 804 determining that the UE 802 should not switch from the first UE model to the second UE model. Alternatively, the UE 802 may perform the compressed communications using the second UE model based at least in part on the UE 802 or the network entity 804 determining that the UE 802 should switch from the first UE model to the second UE model. The network entity 804 may perform the compressed communications using the first NE model based at least in part on the UE 802 or the network entity 804 determining that the network entity 804 should not switch from the first NE model to the second NE model. Alternatively, the network entity 804 may perform the compressed communications using the second NE model based at least in part on the UE 802 or the network entity 804 determining that the network entity 804 should switch from the first NE model to the second NE model.

As indicated above, FIG. 8 is provided as an example. Other examples may differ from what is described with regard to FIG. 8.

### Example Operations of a User Equipment

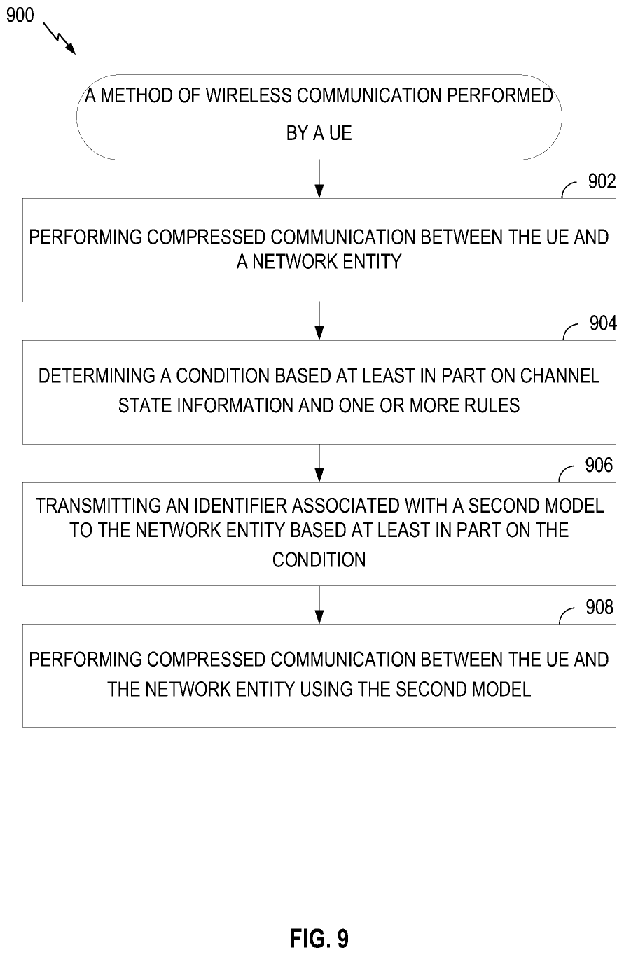

FIG. 9 shows a method 900 for wireless communications by a UE, such as UE 120 of FIGS. 1 and 3.

Method 900 begins at step 902 with performing compressed communication between the UE and a network entity using a first model.

Method 900 then proceeds to step 904 with determining a condition based at least in part on channel state information.

Method 900 then proceeds to step 906 with transmitting an identifier associated with a second model to the network entity based at least in part on the condition.

Method 900 then proceeds to step 908 with performing compressed communication between the UE and the network entity using the second model.

In one aspects, transmitting the identifier associated with the second model to the network entity comprises identifying the second model based at least in part on the condition; and switching from the first model to the second model based at least in part on identifying the second model.

In one aspect, switching from the first model to the second model comprises determining that the second model is to be used for the condition and the first model is not to be used for the condition.

In one aspect, switching from the first model to the second model comprises determining that a performance of the second model associated with the condition is better (e.g., has a better performance indicator for the condition) than a performance of the first model associated with the condition based at least in part on information associated with the first model and the second model.

In one aspect, the condition is at least one of the UE switching between an indoor state and an outdoor state; the UE switching between line-of-sight communications and non-line-of-sight communications; the UE switching between a first vendor and a second vendor; the UE switching between a first geographic location or region and a second geographic location or region; the UE switching between a first serving cell and a second serving cell; a change in one or more channel conditions; or a change in one or more features of the first model or the second model.

In one aspect, the method 900 further includes receiving, from the network entity, information that indicates a plurality of conditions that include the condition.

In one aspect, the one or more rules indicate a delay spread threshold, a signal-to-noise (SNR) ratio threshold, or a Doppler spread threshold, and determining the condition based at least in part on the channel state information and the one or more rules comprises determining that a delay spread satisfies the delay spread threshold, determining that an SNR satisfies the SNR threshold, or determining that a Doppler spread satisfies the Doppler spread threshold.

In one aspect, one of the first model or the second model is based on only a single condition and the other of the first model and the second model is based on a plurality of conditions.

In one aspect, the method 900 further includes monitoring a plurality of models that includes at least one inactive model; and performing compressed communications between the UE and the network entity using a third model based at least in part on determining another condition.

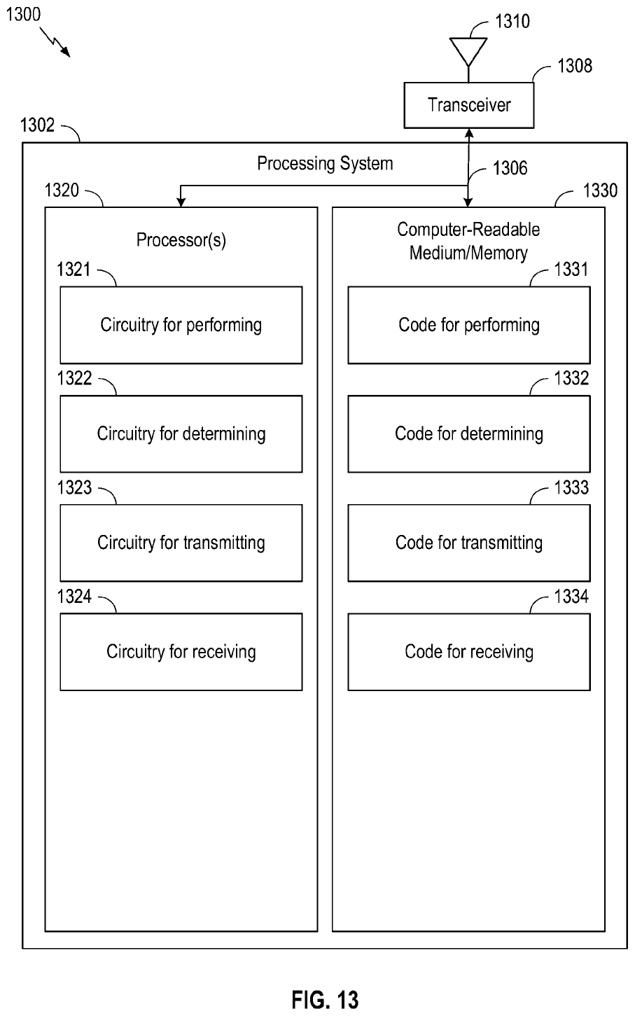

In one aspect, method 900, or any aspect related to it, may be performed by an apparatus, such as communications device 1300 of FIG. 13, which includes various components operable, configured, or adapted to perform the method 900. Communications device 900 is described below in further detail.

Note that FIG. 9 is just one example of a method, and other methods including fewer, additional, or alternative steps are possible consistent with this disclosure.

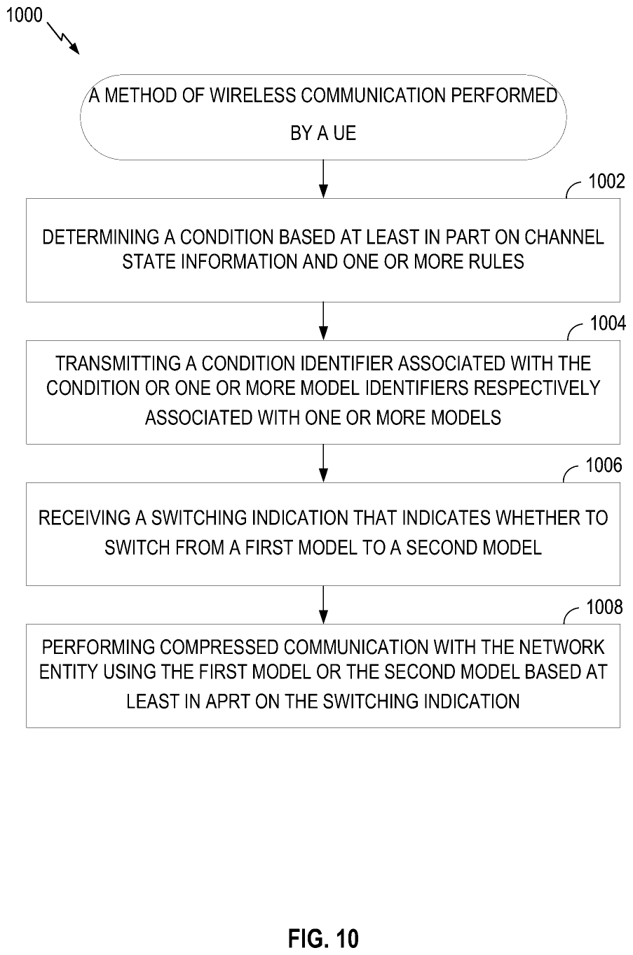

FIG. 10 shows a method 1000 for wireless communications by a UE, such as UE 120 of FIGS. 1 and 3.

Method 1000 begins at step 1002 with determining a condition based at least in part on channel state information.

Method 1000 then proceeds to step 1004 with transmitting a condition identifier associated with the condition or one or more model identifiers respectively associated with one or more models.

Method 1000 then proceeds to step 1006 with receiving, from the network entity, a switching indication that indicates whether to switch from a first model to a second model.

Method 1000 then proceeds to step 1008 with performing compressed communication with the network entity using the first model or the second model based at least in part on the switching indication.

In one aspect, performing the compressed communication with the network entity using the first model or the second model comprises determining to switch from the first model to the second model based at least in part on the switching indication; and switching from the first model to the second model based at least in part on determining to switch from the first model to the second model.

In one aspect, the method 1000 further includes receiving information that indicates a plurality of conditions including the condition.

In one aspect, transmitting the condition identifier comprises transmitting an index that is associated with the condition.

In one aspect, transmitting the condition identifier comprises transmitting a plurality of condition identifiers and a confidence indicator associated with each condition identifier of the plurality of condition identifiers.

In one aspect, the method 1000 further includes receiving information that indicates one or more reporting rules associated with the condition identifier or the one or more model identifiers.

In one aspect, transmitting the condition identifier or the one or more model identifiers comprises transmitting only the condition identifier, and receiving the switching indication comprises receiving a switching indication that includes an indication of the second model.

In one aspect, transmitting the one or more model identifiers comprises transmitting at least one of a UE model identifier and a network entity model identifier.

In one aspect, the method 1000 further includes receiving information that indicates one or more other rules to be used by the UE for selecting the one or more model identifiers based at least in part on the condition.

In one aspect, method 1000, or any aspect related to it, may be performed by an apparatus, such as communications device 1300 of FIG. 13, which includes various components operable, configured, or adapted to perform the method 1000. Communications device 1300 is described below in further detail.

Note that FIG. 10 is just one example of a method, and other methods including fewer, additional, or alternative steps are possible consistent with this disclosure.

### Example Operations of a Network Entity

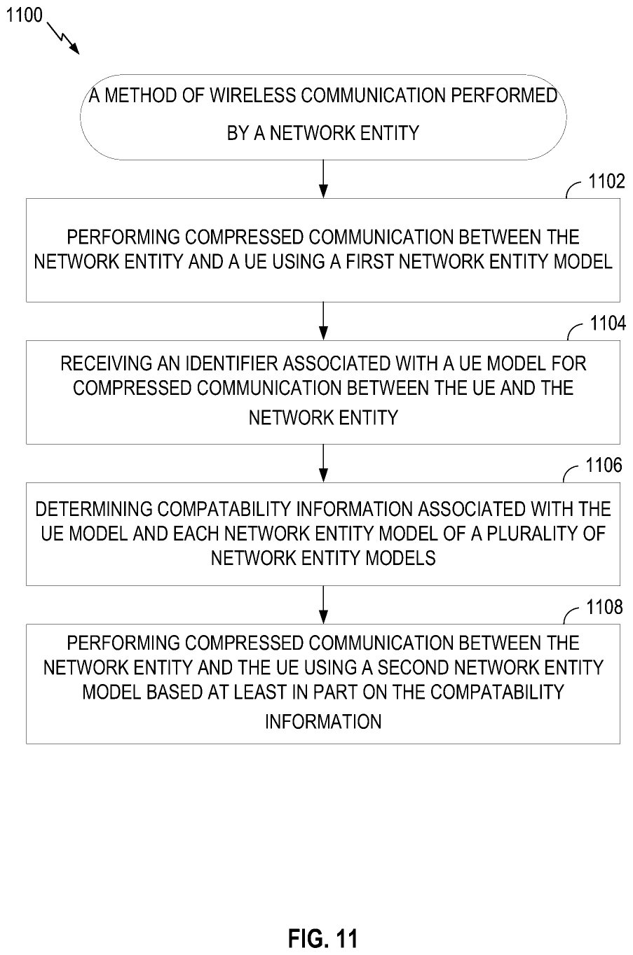

FIG. 11 shows a method 1100 for wireless communications by a network entity, such as BS 110 of FIGS. 1 and 3, or a disaggregated base station as discussed with respect to FIG. 2.

Method 1100 begins at step 1102 with performing compressed communication between the network entity and a UE using a first network entity model.

Method 1100 then proceeds to step 1104 with receiving, from the UE, an identifier associated with a UE model for compressed communication between the UE and the network entity.

Method 1100 then proceeds to step 1106 with determining compatibility information associated with the UE model and each network entity model of a plurality of network entity models.

Method 1100 then proceeds to step 1108 with performing compressed communication between the network entity and the UE using a second network entity model based at least in part on the compatibility information.

In one aspect, the method 1100 further includes determining, based at least in part on the compatibility information, that the first network entity model is not compatible with the UE model and that the second network entity model is compatible with the UE model, wherein performing compressed communication using the second network entity model comprises switching from the first network entity model to the second network entity model based at least in part on the second network entity model being compatible with the UE model.

In one aspect, the method 1100 further includes identifying a plurality of network entity models that are compatible with the UE model, wherein switching from the first network entity model to the second network entity model comprises determining that the second network entity model is more compatible with the UE model than other network entity models of the plurality of network entity models are compatible with the UE model.

In one aspect, the method 1100 further includes determining, based at least in part on the compatibility information, that the first network entity model is less compatible with the UE model than the second network entity model is compatible with the UE model, wherein switching from the first network entity model to the second network entity model comprises switching from the first network entity model to the second network entity model based at least in part on determining that the first network entity model is less compatible with the UE model than the second network entity model is compatible with the UE model.

In one aspect, the method 1100 further includes determining, based at least in part on the compatibility information, that the first network entity model is compatible with the UE model, wherein switching from the first network entity model to the second network entity model comprises determining not to switch from the first network entity model to the second network entity model based at least in part on determining that the first network entity model is compatible with the UE model.

In one aspect, determining that the first network entity model is compatible with the UE model comprises determining that the first network entity model is more compatible with the UE model than other network entity models are compatible with the UE model.

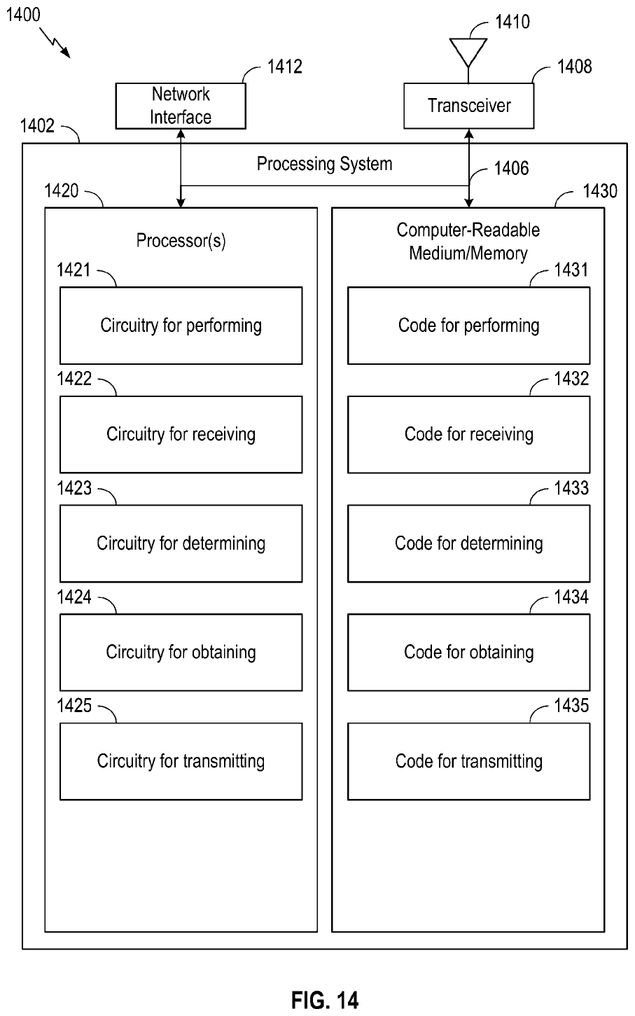

In one aspect, method 1100, or any aspect related to it, may be performed by an apparatus, such as communications device 1400 of FIG. 14, which includes various components operable, configured, or adapted to perform the method 1100. Communications device 1400 is described below in further detail.

Note that FIG. 11 is just one example of a method, and other methods including fewer, additional, or alternative steps are possible consistent with this disclosure.

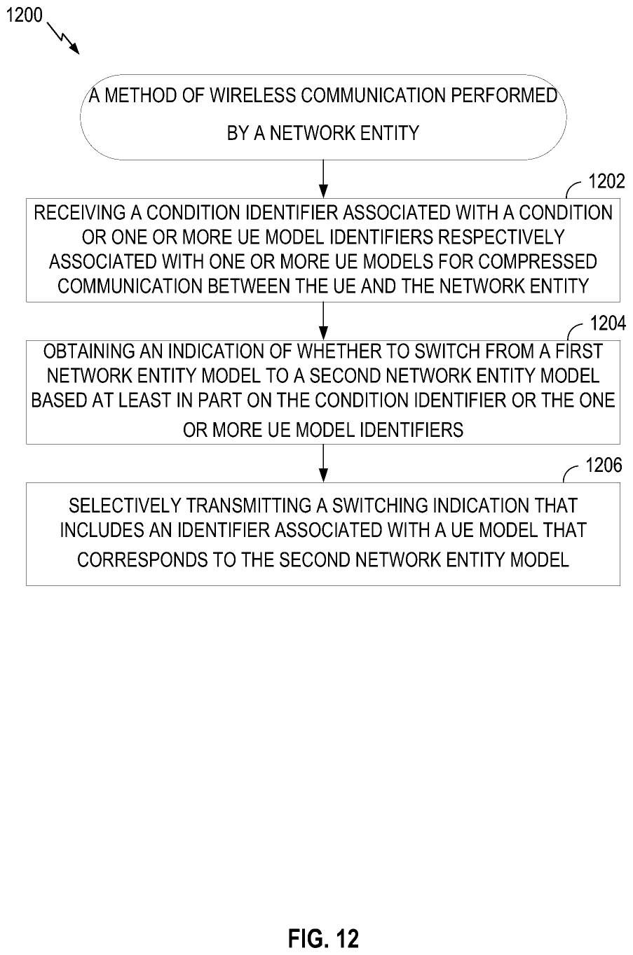

FIG. 12 shows a method 1200 for wireless communications by a network entity, such as BS 110 of FIGS. 1 and 3, or a disaggregated base station as discussed with respect to FIG. 2.

Method 1200 begins at step 1202 with receiving a condition identifier associated with a condition or one or more UE model identifiers respectively associated with one or more UE models for compressed communications between the UE and the network entity.

Method 1200 then proceeds to step 1204 with obtaining an indication of whether to switch from a first network entity model to a second network entity model based at least in part on the condition identifier or the one or more UE model identifiers.

Method 1200 then proceeds to step 1206 with selectively transmitting, to the UE, a switching indication that includes an identifier associated with a UE model that corresponds to the second network entity model.

In one aspect, receiving the condition identifier or the one or more UE model identifiers comprises receiving only the condition identifier, wherein the UE identifies the second network entity model and the UE model that corresponds to the second network entity model based at least in part on the condition identifier.

In one aspect, the method 1200 further includes switching from the first network entity model to the second network entity model, wherein selectively transmitting the switching indication comprises transmitting the switching indication based at least in part on switching from the first network entity model to the second network entity model.

In one aspect, the method 1200 further includes determining whether to accept the one or more UE model identifiers based at least in part on a network constraint or based at least in part on compatibility information.

In one aspect, the method 1200 further includes switching from the first network entity model to the second network entity model based at least in part on accepting the one or more UE model identifiers, wherein selectively transmitting the switching indication comprises transmitting the switching indication based at least in part on switching from the first network entity model to the second network entity model.

In one aspect, the method 1200 further includes transmitting information that indicates a plurality of conditions including the condition.

In one aspect, receiving the condition identifier comprises receiving an index that is associated with the condition.

In one aspect, receiving the condition identifier comprises receiving a plurality of condition identifiers and a confidence indicator associated with each condition identifier of the plurality of condition identifiers.

In one aspect, the method 1200 further includes transmitting information that indicates one or more reporting rules associated with the condition identifier or the one or more UE model identifiers.

In one aspect, the method 1200 further includes transmitting information that indicates one or more other rules to be used by the UE for selecting the one or more UE model identifiers based at least in part on the condition.

In one aspect, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative steps are possible consistent with this disclosure.

### Example Communications Devices

FIG. 13 depicts aspects of an example communications device 1300. In some aspects, communications device 1300 is a user equipment, such as UE 120 described above with respect to FIGS. 1 and 3.

The communications device 1300 includes a processing system 1302 coupled to a transceiver 1308 (e.g., a transmitter and/or a receiver). The transceiver 1308 is configured to transmit and receive signals for the communications device 1300 via an antenna 1310, such as the various signals as described herein. The processing system 1302 may be configured to perform processing functions for the communications device 1300, including processing signals received and/or to be transmitted by the communications device 1300.

The processing system 1302 includes one or more processors 1320. In various aspects, the one or more processors 1320 may be representative of one or more of receive processor 358, transmit processor 364, TX MIMO processor 366, and/or controller/processor 380, as described with respect to FIG. 3. The one or more processors 1320 are coupled to a computer-readable medium memory 1330 via a bus 1306. In certain aspects, the computer-readable medium memory 1330 is configured to store instructions (e.g., computer-executable code) that when executed by the one or more processors 1320, cause the one or more processors 1320 to perform the method 900 described with respect to FIG. 9, the method 1000 described with respect to FIG. 10, or related aspects, Note that reference to a processor performing a function of communications device 1300 may include one or more processors performing that function of communications device 1300.

In the depicted example, computer-readable medium/memory 1330 stores code (e.g., executable instructions) for performing 1331, code for determining 1332, code for transmitting 1333, and code for receiving 1334. Processing of the code 1331-1334 may cause the communications device 1300 to perform the method 900 described with respect to FIG. 9, the method 1000 described with respect to FIG. 10, or any related aspects.

The one or more processors 1320 include circuitry configured to implement (e.g., execute) the code stored in the computer-readable medium/memory 1330, including circuitry for performing 1321, circuitry for determining 1322, circuitry for transmitting 1323, and circuitry for receiving 1324. Processing with circuitry 1321-1324 may cause the communications device 1300 to perform the method 900 described with respect to FIG. 9, the method 1000 described with respect to FIG. 10, or any related aspects.

Various components of the communications device 1300 may provide means for performing the method 900 described with respect to FIG. 9, the method 1000 described with respect to FIG. 10, or any related aspects. For example, means for transmitting, sending, or outputting for transmission may include the transceivers 354 and/or antenna(s) 352 of the UE 120 illustrated in FIG. 3 and/or transceiver 1308 and antenna 1310 of the communications device 1300 in FIG. 13. Means for receiving or obtaining may include the transceivers 354 and/or antenna(s) 352 of the UE 120 illustrated in FIG. 3 and/or transceiver 1308 and antenna 1310 of the communications device 1300 in FIG. 13.

FIG. 14 depicts aspects of an example communications device. In some aspects, communications device 1400 is a network entity, such as BS 110 of FIGS. 1 and 3, or a disaggregated base station as discussed with respect to FIG. 2.

The communications device 1400 includes a processing system 1402 coupled to a transceiver 1408 (e.g., a transmitter and/or a receiver) and/or a network interface 1412. The transceiver 1408 is configured to transmit and receive signals for the communications device 1400 via an antenna 1410, such as the various signals as described herein. The network interface 1412 is configured to obtain and send signals for the communications device 1400 via communications link(s), such as a backhaul link, midhaul link, and/or fronthaul link as described herein, such as with respect to FIG. 2. The processing system 1402 may be configured to perform processing functions for the communications device 1400, including processing signals received and/or to be transmitted by the communications device 1400.

The processing system 1402 includes one or more processors 1420. In various aspects, one or more processors 1420 may be representative of one or more of receive processor 338, transmit processor 320, TX MIMO processor 330, and/or controller/processor 340, as described with respect to FIG. 3. The one or more processors 1420 are coupled to a computer-readable medium memory 1430 via a bus 1406. In certain aspects, the computer-readable medium memory 1430 is configured to store instructions (e.g., computer-executable code) that when executed by the one or more processors 1420, cause the one or more processors 1420 to perform the method 1100 described with respect to FIG. 11, the method 1200 described with respect to FIG. 12, or any related aspects, Note that reference to a processor of communications device 1400 performing a function may include one or more processors of communications device 1400 performing that function.

In the depicted example, the computer-readable medium/memory 1430 stores code (e.g., executable instructions) for performing 1431, code for receiving 1432, code for determining 1433, code for obtaining 1434, and code for transmitting 1435. Processing of the code 1431-1435 may cause the communications device 1400 to perform the method 1100 described with respect to FIG. 11, the method 1200 described with respect to FIG. 12, or any related aspects.

The one or more processors 1420 include circuitry configured to implement (e.g., execute) the code stored in the computer-readable medium/memory 1430, including circuitry for performing 1421, circuitry for receiving 1422, circuitry for determining 1423, circuitry for obtaining 1424, and circuitry for transmitting 1425, a. Processing with circuitry 1421-1425 may cause the communications device 1400 to perform the method 1100 described with respect to FIG. 11, the method 1200 described with respect to FIG. 12, or any related aspects.

Various components of the communications device 1400 may provide means for performing the method 1100 described with respect to FIG. 11, the method 1200 described with respect to FIG. 12, or any related aspects, Means for transmitting, sending, or outputting for transmission may include the transceivers 332 and/or antenna(s) 334 of the BS 110 illustrated in FIG. 3 and/or transceiver 1408 and antenna 1410 of the communications device 1400 in FIG. 14. Means for receiving or obtaining may include the transceivers 332 and/or antenna(s) 334 of the BS 110 illustrated in FIG. 3 and/or transceiver 1408 and antenna 1410 of the communications device 1400 in FIG. 14.

### Example Clauses

Implementation examples are described in the following numbered clauses:

Clause 1: A method of wireless communication performed by a user equipment (UE), comprising: performing compressed communication between the UE and a network entity using a first model: determining a condition based at least in part on channel state information; transmitting an identifier associated with a second model to the network entity based at least in part on the condition; and performing compressed communication between the UE and the network entity using the second model.

Clause 2: The method of Clause 1, wherein transmitting the identifier associated with the second model to the network entity comprises: identifying the second model based at least in part on the condition; and switching from the first model to the second model based at least in part on identifying the second model.

Clause 3: The method of Clause 2, wherein switching from the first model to the second model comprises determining that the second model is to be used for the condition and the first model is not to be used for the condition.

Clause 4: The method of Clause 2, wherein switching from the first model to the second model comprises determining that a performance of the second model associated with the condition is better than a performance of the first model associated with the condition based at least in part on information associated with the first model and the second model.

Clause 5: The method of any of Clauses 1-4, wherein the condition is at least one of: the UE being in an indoor state or an outdoor state; the UE performing line-of-sight communications or non-line-of-sight communications; the UE using a first vendor or a second vendor; the UE being in a first geographic location or a second geographic location; the UE communicating with a first serving cell or a second serving cell; a channel condition; or a model feature.

Clause 6: The method of any of Clauses 1-5, further comprising receiving, from the network entity, information that indicates a plurality of conditions that include the condition.

Clause 7: The method of any of Clauses 1-6, wherein the one or more rules indicate a delay spread threshold, a signal-to-noise (SNR) ratio threshold, or a Doppler spread threshold, and wherein determining the condition based at least in part on the channel state information and the one or more rules comprises determining that a delay spread satisfies the delay spread threshold, determining that an SNR satisfies the SNR threshold, or determining that a Doppler spread satisfies the Doppler spread threshold.

Clause 8: The method of any of Clauses 1-7, wherein one of the first model or the second model is based on only a single condition and the other of the first model and the second model is based on a plurality of conditions.

Clause 9: The method of any of Clauses 1-8, further comprising: monitoring a plurality of models that includes at least one inactive model; detecting the condition or another condition based at least in part on monitoring at least one active model of the plurality of models and the at least one inactive model of the plurality of models; and switching to a third model of the plurality of models based at least in part on detecting the condition or the other condition.

Clause 10: A method of wireless communication performed by a network entity, comprising: performing compressed communication between the network entity and a user equipment (UE) using a first network entity model; receiving, from the UE, an identifier associated with a UE model for compressed communication between the UE and the network entity; determining compatibility information associated with the UE model and each network entity model of a plurality of network entity models; and performing compressed communication between the network entity and the UE using a second network entity model based at least in part on the compatibility information.

Clause 11: The method of Clause 10, further comprising: determining, based at least in part on the compatibility information, that the first network entity model is not compatible with the UE model and that the second network entity model is compatible with the UE model, wherein performing compressed communication using the second network entity model comprises: switching from the first network entity model to the second network entity model based at least in part on the second network entity model being compatible with the UE model.

Clause 12: The method of Clause 11, further comprising identifying a plurality of network entity models that are compatible with the UE model, wherein switching from the first network entity model to the second network entity model comprises determining that the second network entity model is more compatible with the UE model than other network entity models of the plurality of network entity models are compatible with the UE model.

Clause 13: The method of Clause 11, further comprising determining, based at least in part on the compatibility information, that the first network entity model is less compatible with the UE model than the second network entity model is compatible with the UE model, wherein switching from the first network entity model to the second network entity model comprises switching from the first network entity model to the second network entity model based at least in part on determining that the first network entity model is less compatible with the UE model than the second network entity model is compatible with the UE model.

Clause 14: The method of Clause 11, further comprising determining, based at least in part on the compatibility information, that the first network entity model is compatible with the UE model, wherein switching from the first network entity model to the second network entity model comprises determining not to switch from the first network entity model to the second network entity model based at least in part on determining that the first network entity model is compatible with the UE model.

Clause 15: The method of Clause 14, wherein determining that the first network entity model is compatible with the UE model comprises determining that the first network entity model is more compatible with the UE model than other network entity models are compatible with the UE model.

Clause 16: A method of wireless communication performed by a user equipment (UE), comprising: determining a condition based at least in part on channel state information; transmitting, to a network entity, a condition identifier associated with the condition or one or more model identifiers respectively associated with one or more models; receiving, from the network entity, a switching indication that indicates whether to switch from a first model to a second model; and performing compressed communication with the network entity using the first model or the second model based at least in part on the switching indication.

Clause 17: The method of Clause 16, wherein performing the compressed communication with the network entity using the first model or the second model comprises: determining to switch from the first model to the second model based at least in part on the switching indication; and switching from the first model to the second model based at least in part on determining to switch from the first model to the second model.

Clause 18: The method of any of Clauses 16-17, further comprising receiving information that indicates a plurality of conditions including the condition.

Clause 19: The method of Clause 18, wherein transmitting the condition identifier comprises transmitting an index that is associated with the condition.

Clause 20: The method of any of Clauses 16-19, wherein transmitting the condition identifier comprises transmitting a plurality of condition identifiers and a confidence indicator associated with each condition identifier of the plurality of condition identifiers.

Clause 21: The method of any of Clauses 16-20, further comprising receiving information that indicates one or more reporting rules associated with the condition identifier or the one or more model identifiers.

Clause 22: The method of any of Clauses 16-21, wherein transmitting the condition identifier or the one or more model identifiers comprises transmitting only the condition identifier, and wherein receiving the switching indication comprises receiving a switching indication that includes an indication of the second model.

Clause 23: The method of any of Clauses 16-22, wherein transmitting the one or more model identifiers comprises transmitting at least one of a UE model identifier and a network entity model identifier.

Clause 24: The method of any of Clauses 16-23, further comprising receiving information that indicates one or more other rules to be used by the UE for selecting the one or more model identifiers based at least in part on the condition.

Clause 25: The method of any of Clauses 16-24, wherein the condition is at least one of: the UE being in an indoor state or an outdoor state: the UE performing line-of-sight communications or non-line-of-sight communications; the UE using a first vendor or a second vendor; the UE being in a first geographic location or a second geographic location; the UE communicating with a first serving cell or a second serving cell; a channel condition; or a model feature.

Clause 26: The method of any of Clauses 16-25, wherein the one or more rules indicate a delay spread threshold, a signal-to-noise (SNR) ratio threshold, or a Doppler spread threshold, and wherein determining the condition based at least in part on the one or more rules comprises determining that a delay spread satisfies the delay spread threshold, determining that an SNR satisfies the SNR threshold, or determining that a Doppler spread satisfies the Doppler spread threshold.

Clause 27: A method of wireless communication performed by a network entity, comprising: receiving, from a user equipment (UE), a condition identifier associated with a condition or one or more UE model identifiers respectively associated with one or more UE models for compressed communications between the UE and the network entity: obtaining an indication of whether to switch from a first network entity model to a second network entity model based at least in part on the condition identifier or the one or more UE model identifiers; and selectively transmitting, to the UE, a switching indication that includes an identifier associated with a UE model that corresponds to the second network entity model.

Clause 28: The method of Clause 27, wherein receiving the condition identifier or the one or more UE model identifiers comprises receiving only the condition identifier, wherein the UE identifies the second network entity model and the UE model that corresponds to the second network entity model based at least in part on the condition identifier.

Clause 29: The method of Clause 28, further comprising switching from the first network entity model to the second network entity model, wherein selectively transmitting the switching indication comprises transmitting the switching indication based at least in part on switching from the first network entity model to the second network entity model.

Clause 30: The method of any of Clauses 27-29, further comprising determining whether to accept the one or more UE model identifiers based at least in part on a network constraint or based at least in part on compatibility information.

Clause 31: The method of Clause 30, further comprising switching from the first network entity model to the second network entity model based at least in part on accepting the one or more UE model identifiers, wherein selectively transmitting the switching indication comprises transmitting the switching indication based at least in part on switching from the first network entity model to the second network entity model.

Clause 32: The method of any of Clauses 27-31, further comprising transmitting information that indicates a plurality of conditions including the condition.

Clause 33: The method of Clause 32, wherein receiving the condition identifier comprises receiving an index that is associated with the condition.

Clause 34: The method of Clause 32, wherein receiving the condition identifier comprises receiving a plurality of condition identifiers and a confidence indicator associated with each condition identifier of the plurality of condition identifiers.

Clause 35: The method of any of Clauses 27-34, further comprising transmitting information that indicates one or more reporting rules associated with the condition identifier or the one or more UE model identifiers.

Clause 36: The method of Clause 35, further comprising transmitting information that indicates one or more other rules to be used by the UE for selecting the one or more UE model identifiers based at least in part on the condition.

Clause 37: An apparatus for wireless communication at a device, comprising a processor; memory coupled with the processor; and instructions stored in the memory and executable by the processor to cause the apparatus to perform the method of one or more of Clauses 1-36.

Clause 38: A device for wireless communication, comprising a memory and one or more processors coupled to the memory, the one or more processors configured to perform the method of one or more of Clauses 1-36.

Clause 39: An apparatus for wireless communication, comprising at least one means for performing the method of one or more of Clauses 1-36.

Clause 40: A non-transitory computer-readable medium storing code for wireless communication, the code comprising instructions executable by a processor to perform the method of one or more of Clauses 1-36.

Clause 41: A non-transitory computer-readable medium storing a set of instructions for wireless communication, the set of instructions comprising one or more instructions that, when executed by one or more processors of a device, cause the device to perform the method of one or more of Clauses 1-36.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules, and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices (e.g., a combination of a DSP and a microprocessor, a plurality of microprocessors, one or more microprocessors in conjunction with a DSP core, a system on a chip (SoC), or any other such configuration).

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A user equipment (UE) configured for wireless communication, comprising:
one or more memories comprising processor-executable instructions; and
one or more processors configured to execute the processor-executable instructions and cause the UE to:
perform compressed communication between the UE and a network entity using a first model;
determine a condition based at least in part on channel state information;
transmit, to the network entity, an identifier associated with a second model, the condition, or one or more model identifiers respectively associated with one or more models; and
perform compressed communication with the network entity using the second model based at least in part on the condition or a switching indication that indicates whether to switch from the first model to the second model.

2. The UE of claim 1, wherein the identifier is associated with the second model, wherein the one or more processors are configured to execute the processor-executable instructions and cause the UE to perform compressed communication with network entity using the second model based at least in part on the condition.

3. The UE of claim 2, wherein the one or more processors, to cause the UE to transmit the identifier associated with the second model to the network entity, are configured to cause the UE to:
identify the second model based at least in part on the condition; and
switch from the first model to the second model based at least in part on identifying the second model,
wherein the one or more processors, to cause the UE to switch from the first model to the second model, are configured to cause the UE to determine that the second model is to be used for the condition and the first model is not to be used for the condition.

4. The UE of claim 2, wherein the one or more processors, to cause the UE to transmit the identifier associated with the second model to the network entity, are configured to cause the UE to:
identify the second model based at least in part on the condition; and
switch from the first model to the second model based at least in part on identifying the second model,
wherein the one or more processors, to cause the UE to switch from the first model to the second model, are configured to cause the UE to determine that a performance of the second model associated with the condition is better than a performance of the first model associated with the condition based at least in part on information associated with the first model and the second model.

5. The UE of claim 2, wherein the condition is at least one of:
the UE being in an indoor state or an outdoor state;
the UE performing line-of-sight communications or non-line-of-sight communications;
the UE using a first vendor or a second vendor;
the UE being in a first geographic location or a second geographic location;
the UE communicating with a first serving cell or a second serving cell;
a channel condition: or
a model feature.

6. The UE of claim 2, wherein:
the one or more processors, to determine the condition based at least in part on the channel state information, are configured to cause the UE to determine the condition based at least in part on the channel state information and one or more rules,
the one or more rules indicate a delay spread threshold, a signal-to-noise (SNR) ratio threshold, or a Doppler spread threshold, and
the one or more processors, to cause the UE to determine the condition based at least in part on the channel state information and the one or more rules, are configured to cause the UE to determine that a delay spread satisfies the delay spread threshold, determine that an SNR satisfies the SNR threshold, or determine that a Doppler spread satisfies the Doppler spread threshold.

7. The UE of claim 2, wherein one of the first model or the second model is trained based on only a single condition and the other of the first model and the second model is trained based on a plurality of conditions.

8. The UE of claim 2, wherein the one or more processors are further configured to cause the UE to:
monitor a plurality of models that includes at least one inactive model;
detect the condition or another condition based at least in part on monitoring at least one active model of the plurality of models and the at least one inactive model of the plurality of models; and
switch to a third model of the plurality of models based at least in part on detecting the condition or the other condition.

9. The UE of claim 2, wherein the one or more processors, to cause the UE to perform the compressed communication, are configured to cause the UE to transmit or receive a compressed representation of channel state information.

10. (canceled)

11. (canceled)

12. (canceled)

13. (canceled)

14. (canceled)

15. The UE of claim 1,
wherein the identifier is a condition identifier associated with the condition or the one or more model identifiers respectively associated with one or more models;
wherein the one or more processors are configured to execute the processor-executable instructions and cause the UE to:
receive, from the network entity, the switching indication; and
perform compressed communication with the network entity using the second model based at least in part on the switching indication.

16. The UE of claim 15, wherein the one or more processors, to cause the UE to perform the compressed communication with the network entity using the second model, are configured to cause the UE to:
determine to switch from the first model to the second model based at least in part on the switching indication; and
switch from the first model to the second model based at least in part on determining to switch from the first model to the second model.

17. The UE of claim 15, wherein the one or more processors are further configured to cause the UE to receive information that indicates a plurality of conditions including the condition, wherein the one or more processors, to cause the UE to transmit the condition identifier, are configured to cause the UE to transmit an index that is associated with the condition.

18. The UE of claim 15, wherein the one or more processors, to cause the UE to transmit the condition identifier, are configured to cause the UE to transmit a plurality of condition identifiers and a confidence indicator associated with each condition identifier of the plurality of condition identifiers.

19. The UE of claim 15, wherein the one or more processors are further configured to cause the UE to receive information that indicates one or more reporting rules associated with the condition identifier or the one or more model identifiers.

20. The UE of claim 15, wherein the one or more processors, to cause the UE to transmit the condition identifier or the one or more model identifiers, are configured to cause the UE to transmit only the condition identifier, and wherein the one or more processors, to cause the UE to receive the switching indication, are configured to cause the UE to receive a switching indication that includes an indication of the second model.

21. The UE of claim 15, wherein the one or more processors, to cause the UE to transmit the one or more model identifiers, are configured to cause the UE to transmit at least one of a UE model identifier and a network entity model identifier.

22. The UE of claim 15, wherein the one or more processors are further configured to cause the UE to receive information that indicates one or more rules to be used by the UE for selecting the one or more model identifiers based at least in part on the condition.

23. (canceled)

24. (canceled)

25. (canceled)

26. (canceled)

27. (canceled)

28. (canceled)

29. (canceled)

30. (canceled)

31. A method of wireless communication performed by a user equipment (UE), comprising:
performing compressed communication between the UE and a network entity using a first model;
determining a condition based at least in part on channel state information;
transmitting, to the network entity, an identifier associated with a second model, the condition, or one or more model identifiers respectively associated with one or more models; and
performing compressed communication with the network entity using the second model based at least in part on the condition or a switching indication that indicates whether to switch from the first model to the second model.

32. A network entity configured for wireless communication, comprising:
one or more memories comprising processor-executable instructions; and
one or more processors configured to execute the processor-executable instructions and cause the network entity to:
perform compressed communication between the network entity and a user equipment (UE) using a first network entity model;
receive, from the UE, an identifier associated with a UE model for compressed communication between the UE and the network entity;
determine compatibility information associated with the UE model and each network entity model of a plurality of network entity models; and
perform compressed communication between the network entity and the UE using a second network entity model based at least in part on the compatibility information.

33. The network entity of claim 32, wherein the one or more processors are further configured to cause the network entity to:
determine, based at least in part on the compatibility information, that the first network entity model is not compatible with the UE model and that the second network entity model is compatible with the UE model, wherein the one or more processors, to cause the network entity to perform compressed communication using the second network entity model, are configured to cause the network entity to: switch from the first network entity model to the second network entity model based at least in part on the second network entity model being compatible with the UE model: or
identify a plurality of network entity models that are compatible with the UE model, wherein the one or more processors, to cause the network entity to switch from the first network entity model to the second network entity model, are configured to cause the network entity to determine that the second network entity model is more compatible with the UE model than other network entity models of the plurality of network entity models are compatible with the UE model; or
determine, based at least in part on the compatibility information, that the first network entity model is less compatible with the UE model than the second network entity model is compatible with the UE model, and wherein the one or more processors, to cause the network entity to switch from the first network entity model to the second network entity model, are configured to cause the network entity to switch from the first network entity model to the second network entity model based at least in part on determining that the first network entity model is less compatible with the UE model than the second network entity model is compatible with the UE model; or
determine, based at least in part on the compatibility information, that the first network entity model is compatible with the UE model, wherein the one or more processors, to cause the network entity to switch from the first network entity model to the second network entity model, are configured to cause the network entity to determine not to switch from the first network entity model to the second network entity model based at least in part on determining that the first network entity model is compatible with the UE model.
